(19) United States
(12) Patent Application Publication
(10) Pub. No.: US 2025/0222650 A1
(43) Pub. Date: Jul. 10, 2025

(54) SYSTEM AND METHOD FOR CONTINUOUS LAYER-LESS PRINTING OF METAL OBJECTS

(71) Applicants: Xiangjia Li, Chandler, AZ (US); Dylan Joralmon, Tempe, AZ (US)

(72) Inventors: Xiangjia Li, Chandler, AZ (US); Dylan Joralmon, Tempe, AZ (US)

(21) Appl. No.: 19/009,454

(22) Filed: Jan. 3, 2025

Related U.S. Application Data
(60) Provisional application No. 63/618,074, filed on Jan. 5, 2024.

(51) Int. Cl. B29C 64/124; B29C 64/286; B29C 64/386; B29C 64/393; B29K 105/00; B29K 505/10; B33Y 10/00; B33Y 30/00; B33Y 50/00; B33Y 50/02; B33Y 70/10

(52) U.S. Cl. CPC B29C 64/124; B29C 64/286; B29C 64/386; B29C 64/393; B33Y 10/00; B33Y 70/10; B29K 2105/0002; B29K 2105/0064; B29K 2105/0085; B29K 2105/0094; B29K 2505/10; B33Y 30/00; B33Y 50/00; B33Y 50/02

(57) ABSTRACT

A method of fabricating a three-dimensional single, multiple, and gradient metallic object includes mixing a photocurable resin with or dissolving anhydrous metal salt powder to form a metal salt resin, receiving a digital model of the metallic object, receiving a mask image video of the digital model, the mask image video comprised of a collection of two-dimensional mask images that each represent a cross-sectional area of the metallic object, projecting the mask image video and a light beam into a tank containing the metal salt resin, and printing the metallic object with the metal salt resin from the tank as a build platform positioned above the tank moves upward, wherein each cross-sectional area of the metallic object is selectively cured with the light.

### CROSS-REFERENCE TO RELATED APPLICATIONS

This application claims priority to U.S. Application No. 63/618,074, filed Jan. 5, 2024, which is hereby incorporated by reference in its entirety.

### FIELD OF INVENTION

The present disclosure relates to additive manufacturing technologies, and more particularly to a system and method for continuous layer-less printing of metal objects using a mask video projection-based vat photopolymerization process.

### BACKGROUND

Metal additive manufacturing (AM), also known as metal three-dimensional (3D) printing, has recently demonstrated the ability to fabricate geometrically intricate and unique metal and metal alloy objects, with feature sizes ranging from macro to nanoscale structures, when compared to traditional manufacturing technologies. The design flexibility and material selection provided by AM technologies enables the fabrication of low-cost, high resolution metal components with excellent physical properties for use in automotive, aerospace, and biomedical industries. For example, selective laser melting (SLM) and powder bed fusion (PBF) technologies have exhibited the capability to fabricate high strength, impact resistant metal 3D objects, with bioinspired lattice structures, which can withstand extreme thermal environments under high mechanical loading. Furthermore, recent advancements in extrusion- and energy deposition-based metal rapid prototyping technologies have shown that functional graded materials, such as electrodes and heat exchangers, with excellent electrical and thermal conductivity can be manufactured with relative case allowing for rapid and efficient topologically optimized designs via machine learning.

Currently, metal AM technologies can be classified into two discrete regimes based primarily on how the digital model is converted into a physical structure by the deposition of material along a predetermined tool path. Material deposition techniques, such as electron beam melting (EBM) and direct ink writing (DIW), trace a computer-generated tool path to form the metal structures layer-by-layer while simultaneous material deposition processes, such as metal binder jetting (MBJ), employ a selectively controlled surface energy and material deposition tools to construct a single layer instantaneously. However, since the 3D metal structure is constructed layer-by-layer, a conspicuous “staircasing effect,” related to the layer thickness resolution used to generate the tool path or 2D mask images, will significantly influence the surface roughness of the manufactured part which can lead to detrimental effects on the desired functionality. High surface quality metal structures are imperative for applications in electronic devices, optical components, and aerodynamic structures, which impose strict tolerances on surface roughness, where required for adequate performance of the metal part. Moreover, challenges associated with obtaining excellent layer adhesion, using traditional layer-based metal printing technologies, promotes anisotropic behavior of the metal structure, from non-homogeneous physical properties observed in individual layers, which has been found to compromise thermal, electrical, and mechanical properties.

Recent developments in AM technologies that utilize vat photopolymerization (VPP) has made significant improvements in both fabrication speed and surface quality of 3D printed metal, ceramic, and polymer composite structures. VPP is a method that integrates a 2D light beam to solidify selective areas of a photocurable liquid resin layer-by-layer. Two types of VPP techniques, direct light processing (DLP) and stereolithography (SLA), have demonstrated the ability to manufacture high temperature refractory metals and multi-material structures for high performance electrodes with good surface quality and greater resolution when compared with laser energy deposition approaches. However, ceramics and metals printed via DLP and SLA have limited material selection and exhibit anisotropic thermal and mechanical behavior which can facilitate the formation of defects and microcracks during post-processing. Conversely, continuous liquid interface production (CLIP) is a layer-less AM approach that implements an oxygen rich dead zone and 2D light projection to fabricate homogeneous 3D objects with smooth surface features. Since photocurable material continuously refills the fabrication area within the thin oxygen inhibition region, the CLIP process can achieve printing speeds substantially greater than layer-based AM technologies with excellent dimensional accuracy and small feature size. Although significant advancements have been made in improving the resin recoating mechanism and increasing the height of the oxygen inhibition region, there exists several critical limitations on the continuous printing process. One of the more prominent constraints is that continuous layer-less AM processes require low viscosity printing inks, to promote adequate recoating of photocurable material, to attain fast build times. However, in order to achieve dense metallic objects, a high solid loading content of metal precursor powders to a polymer matrix which consequently increases the viscosity of the material, while simultaneously decreasing the light penetration depth and photosensitivity of the material, making it incompatible with layer-less AM processes. Furthermore, the CLIP process can only fabricate small cross-sectional areas since the resin refilling rate is limited by the pressure gradient between the void and surrounding resin. Therefore, challenges of incorporating a metal precursor powder to obtain a low viscosity printing ink for the layer-less fabrication of metallic objects remains to be addressed.

Inorganic metal salts, as a metal precursor additive, have shown promising rheological properties and steric stability when combined with low viscosity acrylic-based resins for metal VPP and DLP technologies. Metal salts are predominantly low-cost and can be incorporated into photocurable slurries/flowing resin, with excellent refractive indices, high solid content, and particle dissolution/dispersion, allowing for the rapid fabrication of robust, high-resolution metal structures, via subsequent oxidation and reduction post-processing methods, for a broad range of metals and alloys. Furthermore, inorganic metal salts show great advantages for the fabrication of homogeneous metal-doped polymer derived ceramics via DLP with high dimensional accuracy. Besides, the methodology for manufacturing metal oxide and metallic structures via metal salt precursors is extraordinarily sustainable. Base metal salt precursor material can be easily synthesized from metal oxide and metallic structures, using rudimentary acid metal chemical reactions, and repurposed for the fabrication of a new metallic part which provides new perspectives on the iterative design of metal 3D printed structures. In contrast to conventional metal precursors, microscale hydrogel scaffolds have demonstrated the capability to fabricate metal and multi-metal components, in parallel, through ionic diffusion into the polymeric matrix. This significantly cases challenges associated with optimizing resin formulations and printing parameters for individual slurries since only the solvent needs to be changed for different metals and alloys. However, since the hydrogel structure must be immersed in a metal solvent to promote the exchange of metal ions, constructing geometrically complex and intricately patterned multi-metal structures remains an issue. Furthermore, the aforementioned metal DLP techniques are layer-based approaches which evince reduced surface quality at microscales and nonhomogeneous physical properties from weak interface adhesion between adjacent layers.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a method of fabricating a three-dimensional metallic object, including: mixing a photocurable resin with anhydrous metal salt powder or dissolving metal salt powder to form a metal salt resin, wherein the metal salt resin is a metal salt slurry or a metal salt liquid resin; dispensing metal salt resin into a light projection area; receiving a digital model of the metallic object; receiving a mask image video of the digital model, the mask image video included of a collection of two-dimensional mask images that each represent a cross-sectional area of the metallic object; projecting the mask image video and a light beam into a tank containing the metal salt resin; and printing the metallic object with the metal salt resin from the tank as a build platform positioned above the tank moves upward, wherein each cross-sectional area of the metallic object is selectively cured with the light.

In some aspects, the techniques described herein relate to a method, wherein the build platform moves upward from the tank at a constant velocity.

In some aspects, the techniques described herein relate to a method, wherein the constant velocity is between 10 μm s-1 and 300 μm s-1.

In some aspects, the techniques described herein relate to a method, wherein printing the metallic object includes a printing speed of at least 107 μm3 s-1 for a feature size of 100 μm.

In some aspects, the techniques described herein relate to a method, wherein the metal salt resin includes 20%-65% (w/w) metal salt such as CuSO4 and a dispersant.

In some aspects, the techniques described herein relate to a method, wherein the dispersant is an ionic copolymer dispersant.

In some aspects, the techniques described herein relate to a method, wherein different types of metal salt resins are dispensed into the resin tank at a controllable deposition rate.

In some aspects, the techniques described herein relate to a method, wherein printing the multi-metallic object includes the formation of alloys and gradient metal structures.

In some aspects, the techniques described herein relate to a system for fabricating a three-dimensional metallic object, including: a tank configured to contain a metal salt resin including a photocurable resin mixed with or dissolving anhydrous metal salt powder; a build platform positioned above the tank; a projection device configured to project a mask image video and a light beam into the tank; and a controller configured to: receive a digital model of the metallic object, generate a mask image video of the digital model included of a collection of two-dimensional mask images that each represent a cross-sectional area of the metallic object, control the projection device to project the mask image video and light beam into the tank, and control movement of the build platform to print the metallic object as the build platform moves upward or control the movement of the tank to achieve linear volumetric printing

In some aspects, the techniques described herein relate to a system, wherein the controller is configured to control the build platform to move upward at a constant velocity between 10 μm s-1 and 300 μm s-1.

In some aspects, the techniques described herein relate to a system, wherein the controller is configured to control printing of the metallic object at a printing speed of at least 107 μm3 s-1 for a feature size of 100 μm.

In some aspects, the techniques described herein relate to a system, wherein the metal salt resin includes 20%-65% (w/w) metal salt such as CuSO4 and a dispersant.

In some aspects, the techniques described herein relate to a system, wherein the dispersant is an ionic copolymer dispersant.

In some aspects, the techniques described herein relate to a system, wherein the ionic copolymer dispersant includes a styrene-maleic anhydride copolymer with quaternized ammonium groups.

In some aspects, the techniques described herein relate to a metal salt resin for fabricating a three-dimensional metallic object, including: a photocurable resin; anhydrous metal salt powder dispersed within or dissolved into the photocurable resin; and a dispersant, wherein the metal salt resin has a viscosity between 0.01 and 1 Pa·s at a shear rate between 10 and 100 s\hat{ }-1.

In some aspects, the techniques described herein relate to a metal salt resin, wherein the anhydrous metal salt powder includes copper sulfate (CuSO4) or a chemical compound formed by the reaction of a metal with an acid.

In some aspects, the techniques described herein relate to a metal salt resin, wherein the anhydrous metal salt powder is present in an amount of 20-65% (w/w) of the metal salt resin.

In some aspects, the techniques described herein relate to a metal salt resin, wherein the dispersant is an ionic copolymer dispersant.

In some aspects, the techniques described herein relate to a metal salt resin, wherein the ionic copolymer dispersant includes a styrene-maleic anhydride copolymer with quaternized ammonium groups.

In some aspects, the techniques described herein relate to a metal salt resin, wherein the photocurable resin includes a mixture of 1,6-hexanediol diacrylate (HDDA) and trimethylolpropane ethoxylate triacrylate (E-TMPTA) or water-soluble photocurable polymer and hydrogel.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a schematic of the MVP-MSL process.

FIG. 1B illustrates a depiction of metal sulfate printing resin with monomer, dispersant, photoinitiator, and metal sulfate constituents.

FIG. 1C illustrates a thermal synthesis process including debinding and sintering followed by thermal reduction for transforming 3D printed green body into metal structures.

FIG. 2A illustrates a cross-linking mechanism for encapsulating metal salt particles.

FIG. 2B illustrates curing characterization.

FIG. 2C illustrates apparent viscosity of metal salt resin under different solid loading conditions.

FIG. 2D illustrates surface quality and cross-linking ratios of cubic specimens fabricated via a MVP-VVP method with scale bars of 200 μm.

FIG. 2E illustrates surface quality and cross-linking ratios of cubic specimens fabricated via a MVP-VVP method with scale bars of 200 μm.

FIG. 2F illustrates surface quality and cross-linking ratios of cubic specimens fabricated via a MVP-VVP method with scale bars of 200 μm.

FIG. 3A illustrates continuous resin flow during part fabrication in the MVP-VPP process.

FIG. 3B illustrates front and top view of cubic structures with different side dimensions displaying surface quality for sufficient and insufficient resin refilling cases.

FIG. 3C illustrates valid side lengths of fabricated parts during continuous resin refilling under different linear stage velocities.

FIG. 3D illustrates simulations of continuous resin flow utilizing different moving speeds.

FIG. 4A illustrates thermal decomposition of embedded CuSO4 to CuO followed by thermal reduction to Cu.

FIG. 4B illustrates SEM images of elemental mapping.

FIG. 4C illustrates the influence of sintering temperature on metallic microstructures.

FIG. 4D illustrates isotropic evaluations of front, top, and bottom surfaces after linear shrinkage.

FIG. 5A illustrates a bioinspired columnar heat sink fabrication overflow from digital model to microstructure.

FIG. 5B illustrates conical horn antenna fabrication overflow from digital model to microstructure.

FIG. 5C illustrates layer-based Cu lattice structures.

FIG. 5D illustrates layerless Cu lattice structures.

FIG. 5E illustrates a distribution of a layerless heat sink with inset of simulation.

FIG. 5F illustrates a printing speed comparison with traditional metal AM techniques.

FIG. 5G illustrates a Cu elephant printed in 21 minutes.

FIG. 5H illustrates a lattice columnar specimen printed in 13 minutes.

FIG. 5I illustrates a kagome space tower printed in 11 minutes.

FIG. 6A illustrates a fabrication process for creating metal precursor parts from metal salt resin.

FIG. 6B illustrates a depiction of recoating process resin with and without dispersant.

FIG. 6C illustrates a post-heat treatment process for synthesizing 3D printed metal structures using copper.

FIG. 7A illustrates mechanisms for particle aggregation and stabilization in a dispersant selection process for generating low viscosity CuSO4 photoresin.

FIG. 7B illustrates sedimentation and turbidity experiments for six different dispersants over 120 h.

FIG. 7C illustrates sedimentation rate results for BYK-2013 over 3 hours.

FIG. 8A illustrates curing characteristics and rheological properties of dispersed metal salt resins displaying an illustration of light penetration effect for dispersed and non-dispersed resin systems.

FIG. 8B illustrates a working curve of 50% (w/w) CuSO4 resin at different light intensities.

FIG. 8C illustrates viscosity results for printing resins with varying concentration of dispersant and CuSO₄.

FIG. 8D illustrates surface quality results using the optimal printing speed for solid loadings of 50% (w/w), 55% (w/w), and 60% (w/w).

FIG. 9A illustrates water resistance evaluation of CuSO4 printing resins and TGA-guided post processing optimization showing resin stability during continuous fabrication of CuSO₄ resin with and without dispersant.

FIG. 9B illustrates copolymer self-assembly on the particle surface and water resistance mechanism.

FIG. 9C illustrates TGA and DSC results and generated temperature profiles for each post-heat treatment step.

FIG. 10A illustrates thermal synthesis of metal from 3D printed precursor objects showing heat treatment of a 3D printed cubic gyroid to obtain Cu metal with and without dispersant.

FIG. 10B illustrates surface morphology of Cu gyroid with and without dispersant with inset SEM images displaying the microstructure and grain size.

FIG. 10C illustrates EDS of Cu gyroid.

FIG. 10D illustrates linear shrinkage results for dispersed and non-dispersed precursor objects.

FIG. 11A illustrates apparent viscosity of metal sulfate materials with and without TX-100.

FIG. 11B illustrates a TGA curve of a printed metal salt green body.

FIG. 11C illustrates SEM images copper fabricated through (i) layer-based printing, (ii) bottom surface layerless printing, (iii) front surface layerless printing, and (iv) top surface layerless printing with scale bars of (i) 20 μm, (ii) 20 μm, (iii) 40 μm, and (iv) 40 μm.

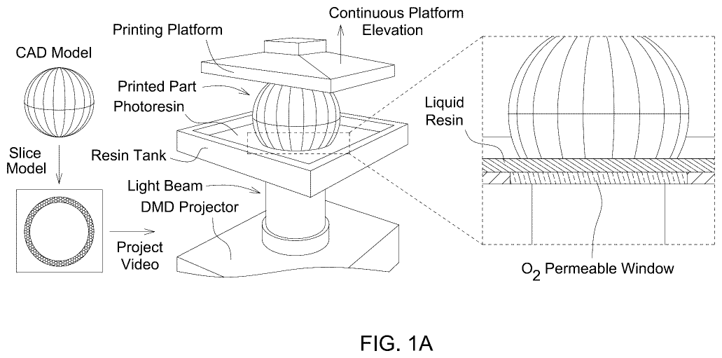

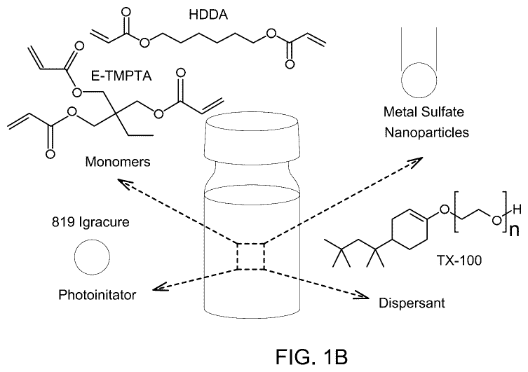

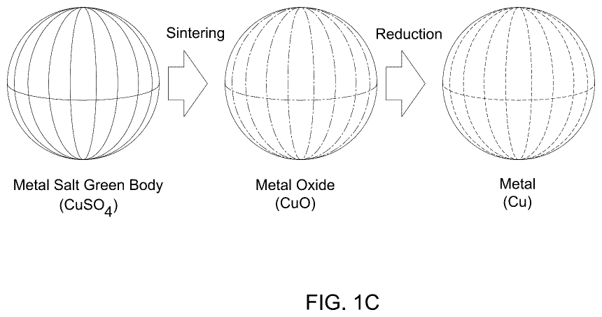

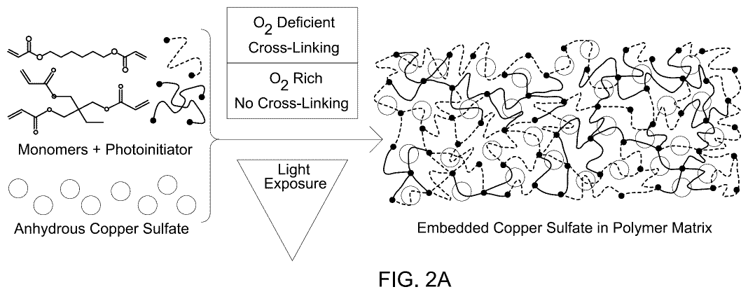

FIG. 1D illustrates a 3D printed copper heat exchanger printed in 13 minutes, shown with a scale bar at 2 mm.

FIG. 12A illustrates post-processing of CuNi lattices with 10% Ni content with SEM images showing microstructure during each stage.

FIG. 12B illustrates EDS and shrinkage analysis of columnar gyroid specimens with 30% Ni content.

FIG. 12C illustrates microstructure evaluation for 30% Ni and 10% CuNi lattices with bio-inspired structures with small feature sizes.

FIG. 12D illustrates increased porosity as Ni content is increased for the same sintering temperature.

FIG. 12E illustrates a demonstration of multi-metal printing using the MMVP-VPP process.

FIG. 13A illustrates maximum printing speeds for Kelvin lattice structures with solid loading concentrations ranging from 40% (w/w) to 60% (w/w) for single metal.

FIG. 13B illustrates maximum printing speeds for Kelvin lattice structures with solid loading concentrations ranging from 40% (w/w) to 60% (w/w) for alloy metal with 10% Ni content.

FIG. 14A illustrates an overview of multi-metal CLIP printing displaying metal precursor dispensing and 3D printer schematic to generate multi-metal lattices with Cu/CuNi gradient.

FIG. 14B illustrates an overview of multi-metal CLIP printing displaying material exchange process during continuous 3D printing.

FIG. 15A illustrates particle-less and layer-less AM method showing a material system and a working principle of water-based precursor integrating into the metal CLIP printing process.

FIG. 15B illustrates particle-less and layer-less AM method showing an application of water-based inks for multi-material 3D printing.

FIG. 15C illustrates particle-less and layer-less AM method showing volumetric 3D printing.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The metal mask video projection-based vat photopolymerization (MMVP-VPP) process may provide a novel approach to metal additive manufacturing with several key advantages over traditional methods. This process may enable the fabrication of three-dimensional metallic objects with high resolution, smooth surfaces, and isotropic properties.

In some cases, the MMVP-VPP process may begin with receiving a digital model of the desired metallic object. The digital model may then be processed to generate a mask image video comprised of a collection of two-dimensional mask images. Each mask image may represent a cross-sectional area of the metallic object.

A system for fabricating the three-dimensional metallic object may comprise several key components. In some implementations, the system may include a tank configured to contain a metal salt resin. The metal salt resin may comprise a photocurable resin mixed with anhydrous metal salt powder. A build platform may be positioned above the tank.

The system may also include a projection device configured to project the mask image video and a light beam into the tank. A controller may be configured to receive the digital model, generate the mask image video, control the projection device, and control movement of the build platform.

During the fabrication process, the mask image video and light beam may be projected into the tank containing the metal salt resin. As the build platform moves upward at a controlled rate, each cross-sectional area of the metallic object may be selectively cured with the projected light. This continuous upward movement of the build platform, combined with the projection of successive mask images, may allow for layer-less printing of the metallic object.

The metal salt resin may continuously recoat the fabrication area as the build platform rises, enabling rapid and continuous production. This approach may circumvent limitations of traditional layer-by-layer methods, potentially allowing for faster fabrication speeds and improved surface quality.

In some cases, the MMVP-VPP process may enable the production of complex metallic structures with microscale features and smooth surfaces. The continuous nature of the fabrication process may result in objects with more homogeneous properties compared to layer-based methods.

After the printing process, the fabricated object may undergo post-processing steps to convert the metal salt precursor into a final metallic structure. These steps may include debinding, sintering, and thermal reduction, which will be discussed in more detail in subsequent sections.

In some cases, a metal salt resin may be prepared for use in the MMVP-VPP process. The metal salt resin may comprise a photocurable resin, anhydrous metal salt powder dispersed within the photocurable resin, and a dispersant.

The anhydrous metal salt powder may be prepared by dehydrating a hydrated metal salt. In some implementations, copper sulfate pentahydrate may be dehydrated at 400° C. for 5 hours to form anhydrous copper sulfate (CuSO₄). The anhydrous metal salt powder may comprise copper sulfate (CuSO₄).

The photocurable resin may comprise a mixture of monomers. In some cases, the photocurable resin may include a mixture of 1,6-hexanediol diacrylate (HDDA) and trimethylolpropane ethoxylate triacrylate (E-TMPTA) or water-soluble photocurable polymer.

A dispersant may be added to the photocurable resin to improve the stability and rheological properties of the metal salt resin. In some implementations, the dispersant may be an ionic copolymer dispersant. The ionic copolymer dispersant may comprise a styrene-maleic anhydride copolymer with quaternized ammonium groups. In some cases, BYK-2013 may be used as the dispersant.

To form the metal salt resin, the anhydrous metal salt powder may be mixed with the photocurable resin containing the dispersant. In some implementations, a planetary ball mill operating at 300 RPM may be used to mix the components overnight. This mixing process may help achieve a uniform dispersion of the metal salt powder within the resin.

The concentration of anhydrous metal salt powder in the metal salt resin may be adjusted to achieve desired properties. In some cases, the anhydrous metal salt powder may be present in an amount of 30-65% (w/w) of the metal salt resin. In certain implementations, the metal salt resin may comprise 65% (w/w) CuSO₄.

The dispersant plays a crucial role in achieving a stable, low-viscosity resin suitable for the MMVP-VPP process. In some cases, the metal salt resin may have a viscosity between 0.01 and 1 Pa·s at a shear rate between 10 and 100 s-1. This low viscosity may allow for efficient recoating during the continuous fabrication process.

By carefully controlling the composition and preparation of the metal salt resin, a stable and printable material may be obtained for use in the MMVP-VPP process. The combination of anhydrous metal salt powder, photocurable resin, and dispersant may enable the fabrication of high-quality metal precursor structures.

In some cases, the MMVP-VPP process may utilize a continuous fabrication approach that differs significantly from traditional layer-based methods. This continuous nature may allow for the production of three-dimensional metallic objects without distinct layers, potentially resulting in improved surface quality and more homogeneous properties.

The process may begin with the generation of a mask image video from a digital model of the desired object. In some implementations, the digital model may be sliced into two-dimensional cross-sections using a slicing thickness of 5 microns. These cross-sectional images may then be compiled into a high-frame-rate video that represents the entire object.

During fabrication, a build platform may be positioned above a tank containing the metal salt resin. The build platform may move upward from the tank at a constant velocity. In some cases, this constant velocity may be between 10 μm s-1 and 300 μm s-1. In certain implementations, the constant velocity may be about 100 μm s-1. This continuous upward movement may allow for uninterrupted fabrication of the object.

As the build platform rises, a projection device may project the mask image video and a light beam into the tank. In some implementations, a 405 nm wavelength light may be used. The projection device may include a digital micromirror device (DMD) with an array of 1920×1080 micromirrors. This setup may allow for precise control over which areas of the resin are exposed to light and subsequently cured.

The continuous nature of the MMVP-VPP process may enable the fabrication of complex structures with high resolution and smooth surfaces. In some cases, this process may be used to create intricate objects such as heat sinks, antennas, and lattice structures. The ability to fabricate these complex geometries may be attributed to the continuous, layer-less nature of the process, which may avoid issues associated with layer boundaries in traditional additive manufacturing methods.

As each frame of the mask image video is projected, the corresponding cross-section of the object may be selectively cured in the resin. The continuous upward movement of the build platform may allow newly cured material to be constantly lifted out of the resin, while fresh, uncured resin flows into the fabrication area. This continuous recoating process may contribute to the smooth, layer-less nature of the fabricated objects.

The MMVP-VPP process may offer several potential advantages over traditional layer-based methods. By eliminating distinct layers, the process may reduce or eliminate the “staircase effect” often seen in layer-based additive manufacturing. Additionally, the continuous nature of the fabrication may allow for faster production times, as there may be no need to pause between layers for recoating or repositioning.

In some cases, the resin flow dynamics during the fabrication process may significantly impact the quality and speed of printing. The metal salt resin may flow into the fabrication area as the build platform moves upward, continuously replenishing the material available for curing. This continuous recoating process may be critical for achieving high-quality, layer-less prints.

The viscosity of the metal salt resin may play a crucial role in determining the maximum achievable printing speed. In some implementations, a low viscosity resin may allow for faster recoating and thus faster overall printing speeds. The addition of a dispersant to the metal salt resin may help achieve the desired low viscosity while maintaining a high solid loading of metal salt particles.

The controller may be configured to control the movement of the build platform during the fabrication process. In some cases, the controller may be configured to control the build platform to move upward at a constant velocity between 10 μm s⁻¹ and 300 μm s⁻¹. This controlled upward movement may allow for consistent resin flow and curing throughout the printing process.

The relationship between printing speed, resin properties, and print quality may be complex. In some implementations, faster printing speeds may require careful optimization of resin properties to maintain print quality. The controller may be configured to adjust printing parameters based on the specific properties of the metal salt resin being used.

In some cases, the controller may be configured to control printing of the metallic object at a printing speed of at least 10⁷ μm³ s⁻¹ for a feature size of 100 μm. This high printing speed may be achievable due to the continuous nature of the fabrication process and the optimized resin flow dynamics. The ability to print at such high speeds while maintaining feature sizes of 100 μm may represent a significant advancement over traditional layer-based metal additive manufacturing techniques.

The printing speed of at least 10⁷ μm³ s⁻¹ for a feature size of 100 μm may be facilitated by the continuous recoating process and the precise control over resin curing provided by the mask video projection system. This combination of high speed and fine feature resolution may enable the rapid production of complex metallic structures with smooth surfaces and high dimensional accuracy.

To achieve optimal print quality at high speeds, the resin flow dynamics may need to be carefully managed. In some implementations, the controller may adjust parameters such as light intensity, exposure time, and build platform velocity based on real-time feedback from the printing process. This adaptive control may help maintain consistent resin flow and curing even as printing conditions change throughout the fabrication of a complex object.

In some cases, the printed green body may undergo post-processing steps to convert the metal salt precursor into a final metallic structure. The post-processing may involve debinding, sintering, and thermal reduction processes.

After fabrication, the green body may be washed in 1,6-hexanediol diacrylate (HDDA) for 15 minutes using ultrasonication. This washing step may help remove any uncured resin from the surface of the printed structure.

The debinding process may be performed to remove organic components from the green body. In some implementations, debinding may be carried out in a tube furnace under an inert atmosphere. The temperature may be incrementally increased to specific dwell temperatures of 215° C., 360° C., 415° C., and 600° C. Each dwell temperature may be maintained for a period of time, such as 2 hours. This gradual heating process may help prevent rapid outgassing and preserve the structural integrity of the printed object.

Following debinding, the structure may undergo sintering to form a metal oxide. In some cases, sintering may be performed in a muffle furnace in an air atmosphere. The temperature may be increased to dwell temperatures of 705° C. and 785° C., with each temperature maintained for a period such as 2 hours. This sintering process may promote the formation of metal oxide particles and initiate densification of the structure.

The final step in the post-processing may involve thermal reduction to convert the metal oxide structure into a metallic object. In some implementations, thermal reduction may be conducted in a tube furnace under a reducing atmosphere of 5% H₂/Ar. The temperature may be raised to 800° C. and maintained for 10 hours. This reduction process may transform the metal oxide into pure metal while preserving the overall structure of the printed object.

The post-processing steps may significantly affect the final product. Debinding may remove organic components while maintaining the overall shape of the printed structure. Sintering may increase the density and strength of the object by promoting particle bonding. The thermal reduction process may convert the metal oxide to pure metal, potentially resulting in further densification and the development of the final metallic microstructure.

In some cases, the post-processing parameters may be optimized based on thermogravimetric analysis (TGA) of the printed green bodies. This analysis may help identify critical temperature ranges for organic removal and metal oxide formation, allowing for more precise control over the post-processing steps.

The combination of these post-processing steps—washing, debinding, sintering, and thermal reduction—may enable the conversion of the printed metal salt precursor structure into a final metallic object with desired properties and microstructure.

In some cases, the MMVP-VPP process may offer several key advantages over traditional metal additive manufacturing methods. The continuous, layer-less nature of the fabrication process may result in improved surface quality of the printed objects. By eliminating distinct layers, the MMVP-VPP process may reduce or eliminate the “staircase effect” often observed in layer-based additive manufacturing, potentially leading to smoother surfaces without the need for extensive post-processing.

The MMVP-VPP process may enable the production of metallic objects with more isotropic properties compared to layer-based methods. In some cases, the continuous fabrication approach may result in a more homogeneous microstructure throughout the printed object. This uniformity may lead to more consistent mechanical, thermal, and electrical properties in all directions, which may be particularly beneficial for applications requiring predictable and reliable performance.

Another potential advantage of the MMVP-VPP process may be faster printing speeds compared to traditional metal additive manufacturing techniques. In some cases, the continuous nature of the fabrication process, combined with optimized resin flow dynamics, may allow for printing speeds of at least 10⁷ μm³ s⁻¹ for a feature size of 100 μm. This high-speed capability may significantly reduce production times for complex metallic structures.

The MMVP-VPP process may find applications across various industries. In the aerospace sector, the ability to rapidly produce complex, lightweight metal structures with high dimensional accuracy may be valuable for creating components such as heat exchangers, turbine blades, or structural elements. The improved surface quality and isotropic properties may be particularly beneficial for parts subject to high stresses or extreme environmental conditions.

In the biomedical field, the MMVP-VPP process may enable the fabrication of intricate metal implants or surgical instruments with fine features and smooth surfaces. The ability to create porous structures with controlled geometries may be useful for developing bone scaffolds or other tissue engineering applications.

The automotive industry may benefit from the MMVP-VPP process for rapid prototyping of metal components or for producing complex parts with optimized geometries for weight reduction or improved performance. The high-speed printing capability may be particularly advantageous for reducing lead times in product development cycles.

In the electronics industry, the MMVP-VPP process may be used to create complex metal heat sinks, antennas, or other components with precise geometries and smooth surfaces. The ability to produce parts with consistent electrical and thermal properties may be valuable for ensuring reliable performance in electronic devices.

The MMVP-VPP process may also have applications in the field of jewelry and decorative arts, where the ability to create intricate metal structures with smooth surfaces and fine details may be highly desirable. The process may enable the production of unique designs that would be difficult or impossible to achieve with traditional manufacturing methods.

In some cases, the versatility of the MMVP-VPP process in terms of material selection may further expand its potential applications. The ability to work with various metal salts may allow for the production of objects in a wide range of metals and alloys, potentially including materials that are challenging to process using other additive manufacturing techniques.

A number of implementations have been described. Nevertheless, it will be understood that various modifications may be made without departing from the spirit and scope of the disclosure. Accordingly, other implementations are within the scope of the following claims.

FIG. 1A illustrates a mask video projection-based vat photopolymerization (MVP-VPP) process accordingly to an embodiment of the present disclosure. The MVP-VPP process may circumvent material and printing speed limitations of current metal AM technologies by integrating a low viscosity metal salt precursor resin (see FIG. 1B) and high frame rate video, generated from the digital model, that uniformly deposits and crosslinks new material in the projection area promoting the continuous fabrication of 3D metallic objects.

As described below, curing characterization and rheological behavior is investigated to ascertain nominal fabrication speeds based on mean resin refilling and photopolymerization mechanisms. Optimized post-processing parameters, guided through thermogravimetric analysis (TGA) of printed metal salt green bodies, are evaluated with the purpose of efficiently converting the printed structure into the desired metallic structure via debinding, sintering, and thermal reduction (see FIG. 1C).

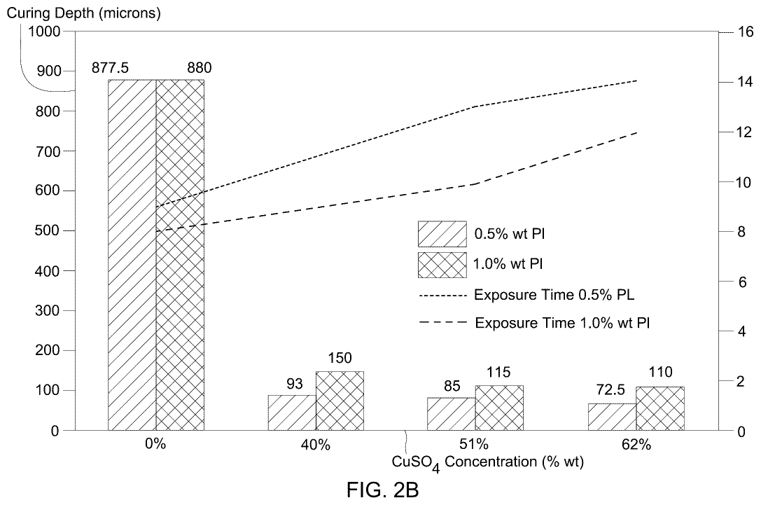

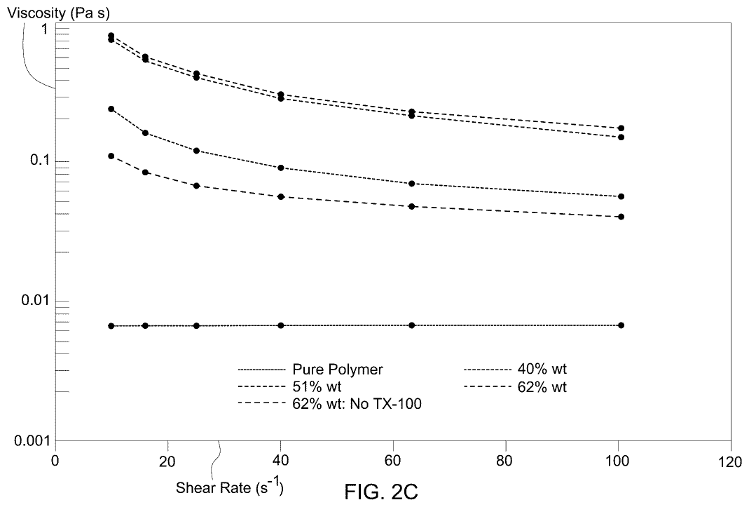

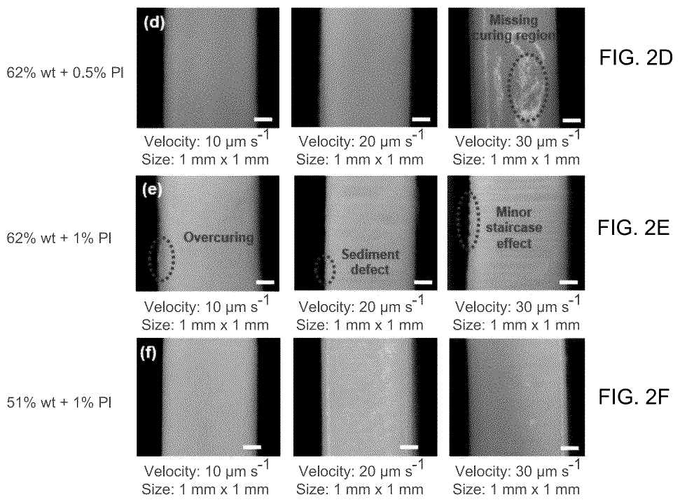

Inorganic metal salts can readily be dispersed in acrylate-based polymers, along with a photoinitiator (PI), for the fabrication of 3D layer-less metal precursor objects through the MVP-VPP approach. Selective cross-linking of organic monomers occurs through free radical photopolymerization, upon incident light exposure of the 2D pattern light beam, in regions on the metal salt resin that are oxygen deficient to obtain a homogenous distribution of encapsulated metal salt particles, see FIG. 2A. From this depiction, as the concentration of metal salt particles increases, the number of mean pathways for light to penetrate the material and promote the photopolymerization process decreases since the light is scattered by metal salt particles. Curing characteristics of printing resin with different concentrations of PI and solid loading of CuSO₄ particles are investigated for the fabrication of metal components using the MVP-VPP process. The required exposure time and resulting curing depth is heavily influenced by the dispersion of CuSO₄ particles and photosensitivity of the polymeric matrix. As depicted in FIG. 2B, the curing depth of pure photocurable resin decreases dramatically with the addition of 40% (w/w) CuSO₄ particles from 877.5 μm to 93 μm and 880 μm to 150 μm for resins with 0.5% (w/w) and 1% (w/w) PI, respectively. Moreover, increasing the concentration of CuSO₄ from 40% (w/w) to 62% (w/w) leads to a relatively small reduction in curing depth, for both 0.5% (w/w) and 1% (w/w) PI material, by approximately 20 to 40 microns. An accurate mathematical model is utilized to express the relationship between energy distribution and light penetration for determining the curing depth of CuSO₄ resin. The curing model for the MVP-VPP process can be evaluated through the working principle of Jacobs, using Equation 1 where Dₚ is the penetration depth in the CuSO₄ printing resin where the light intensity decreases gradually to e⁻¹ of the light intensity at the bottom of the resin vat, E₀ is the energy at the surface of the material, and E_{Cr} is the critical energy requirement necessary to initiate the photopolymerization process.

$${C}_{d} = {D}_{p} ln ( \frac{{E}_{0}}{{E}_{{c}_{r}}} ) \qquad Eq . 1$$

Additionally, experimental results show that as the solid loading of CuSO₄ particles increases, the exposure time required to adequately cure a thin film of material increases. For example, at a constant light intensity, an exposure time of 10 seconds is needed to cure 40% (w/w) CuSO₄ resin while 14 seconds is required for a 62% (w/w) CuSO₄ resin. A similar trend is observed in printing material with a higher concentration of PI, however shorter exposure times are required when compared to the 0.5% (w/w) material. As more CuSO₄ particles are introduced into the polymeric matrix, the mean distance between adjacent particles decreases significantly resulting in light scattering effects that prevent the 2D patterned light beam from penetrating the photocurable resin to promote the photopolymerization process. Therefore, the apparent viscosity of the material, which can be used to quantify the impact of dispersant on rheological stability, is closely related to the photosensitivity of the printing material with higher viscosities resulting in longer exposure times and smaller curing depths when compared to pure photocurable resin. Consequently, the exposure times and curing depths are used to set the printing parameters for the fabrication of high-resolution 3D precursor metal objects with smooth, layer-less surface finish during the MVP-VPP process.

The rheological behavior of metal salt resins under different solid loading conditions of copper sulfate (CuSO₄) is studied using a shear rate sweep test from 10 s⁻¹ to 100 s⁻¹. Apparent viscosity of the resin is significantly impacted by the concentration of CuSO₄ particles and the addition of the dispersant Triton X-100 (TX-100) into the polymeric matrix. The primary role of the dispersant is to generate a stable printing ink by preventing agglomeration of adjacent metal sulfate particles within the polymer solution via hydrophobic and hydrophilic interactions between the solid and liquid phases. As shown in FIG. 2B, when the concentration of CuSO₄ is increased from 40% (w/w) to 62% (w/w), the viscosity increases from 0.068 Pa s⁻¹ to 0.41 Pa s⁻¹ for a shear rate of 25 rad s⁻¹. Furthermore, the apparent viscosity of 51% (w/w) and 62% (w/w) CuSO₄ resins are nearly identical, indicating that increasing CuSO₄ up to the maximum threshold has a negligible effect on the materials viscosity. The observed shear rate sweep curves for all CuSO₄ bearing resins exhibit shear thinning behavior, when compared with pure photoresin, since higher shear rates promote deagglomeration of CuSO₄ clusters which subsequently lowers the viscosity of the material. Furthermore, since low viscosity printing resins, within the range of Oct. 1, 2010-2 Pa s⁻¹, can be achieved through this method, the liquid phase can more readily recoat the bottom surface of the resin and thus deliver microparticles homogeneously to the fabrication area while improving the mean resin refilling speed.

Comparison of printing material containing 62% (w/w) CuSO₄ resin with and without the dispersant TX-100 demonstrates the effect of dispersant on rheological stability of the resin during the continuous fabrication. Shear sweep curves decreases slightly from 0.80 to 0.24 Pa s⁻¹ for resin with and without TX-100 at a shear rate of 10 rad s⁻¹, respectively. However, CuSO₄ resin without TX-100 is highly unstable and spontaneously flocculates within minutes, forming large aggregates of CuSO₄. Agglomerations present within the CuSO₄ resin during continuous printing can alter the materials local viscosity and photosensitivity resulting in poor structural integrity, green body defects, and low-resolution printed structures. Although separation can also be observed in CuSO₄ printing resins containing TX-100, the onset of sedimentation is typically on the timescale of hours. Furthermore, dispersant carrying resins can be readily homogenized and utilized in the MVP-VPP process, showing improved printability and shelf-life of dispersant carrying CuSO₄ resins. Consequently, the 62% (w/w) CuSO₄ with TX-100 exhibits low apparent viscosity, high solid loading percentage, and good rheological stability, the material can be readily incorporated into the layer-less 3D metal objects through MVP-VPP.

To optimize the printing parameters of the MVP-VPP process, the influence of printing speed and photosensitivity on the surface quality of metal sulfate structures is investigated. A 2D light beam in the pattern of a 1 mm×1 mm square is reflected by the optical system on the surface of the photosensitive metal sulfate resin while the velocity of the linear stage is set between 10 μm s⁻¹ and 30 μm s⁻¹. As depicted in FIG. 2D, 62% (w/w) CuSO₄ resin with 0.5% PI shows excellent surface roughness and cross-linking ratio for linear stage velocities up to 20 μm s⁻¹; however, beyond this threshold the fabricated samples begin to exhibit substantial dimensional deviations from the target 3D object. For example, setting the linear stage velocity to 30 μm s⁻¹ results in green body structures with missing portions observed on the surface since the rate of monomer cross-linking within the material is insufficient when compared to the speed of the build platform leading to uncured regions in the final structure. Moreover, experimental results show that when the concentration of photoinitiator is increased to 1% (w/w), for the same solid loading of CuSO₄, the surface quality decreases for samples fabricated using a velocity of 10 μm s⁻¹ which exhibits characteristics of overcuring, see FIG. 2E. For the same material, linear stage velocities of 20 μm s⁻¹ improves the dimensional accuracy and surface quality of the MVP-VPP printing structure significantly and demonstrates minor sediment defects from agglomerations present in the projection area during fabrication. Moreover, increasing the printing speed to 30 μm s⁻¹ partially mitigates the missing cured portions seen in the 0.5% (w/w) PI solution however a conspicuous “staircasing effect” can be observed indicating that material is not fully cross-linked. Depicted in FIG. 2F, as the solid loading of CuSO₄ is reduced from 62% (w/w) to 51% (w/w), the surface quality of material with 1% PI shows significant improvement even for a linear velocity equal to 30 μm s⁻¹. Consequently, linear stage velocities that exceed 20 μm s⁻¹ exhibit a higher risk for micropore defects that can be attributed to insufficient resin filling for manufacturing larger cross-sectional areas during the MVP-VPP process. Therefore, MVP-VPP printing parameters may be constrained by both the rate of liquid refilling and photocuring within the boundary of the projection area. To validate the liquid refilling postulation, a mathematical model is constructed and compared against a series of experiments and simulations which are discussed below.

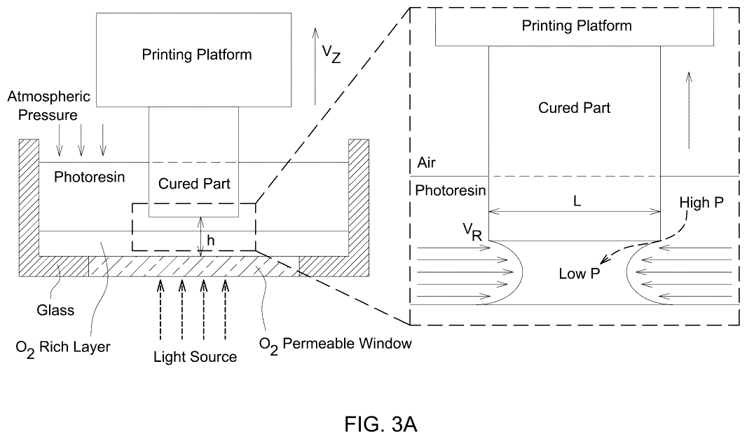

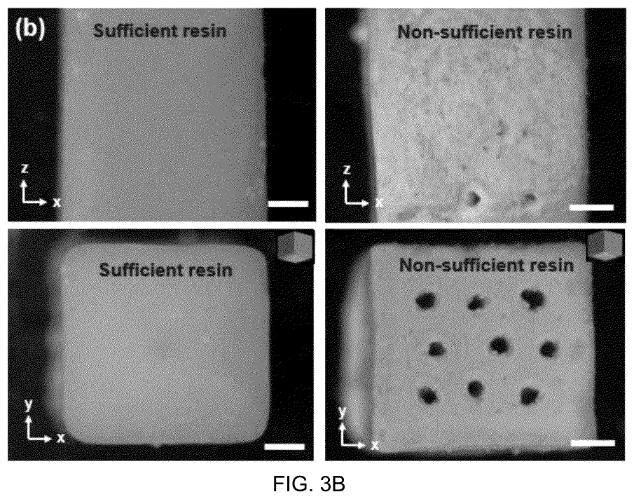

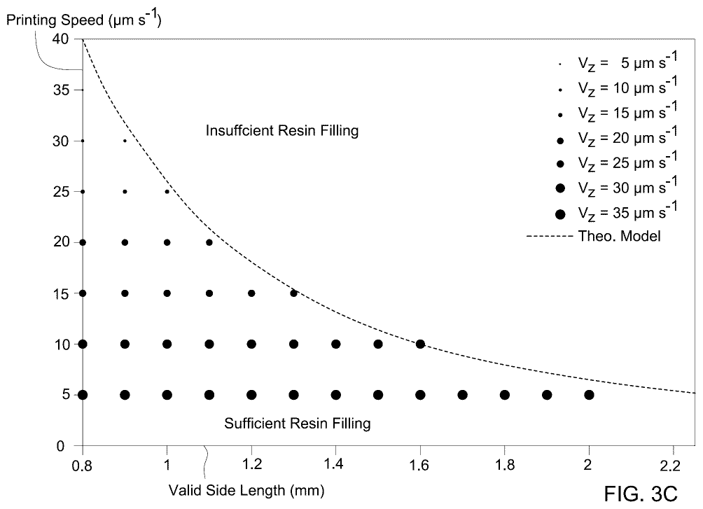

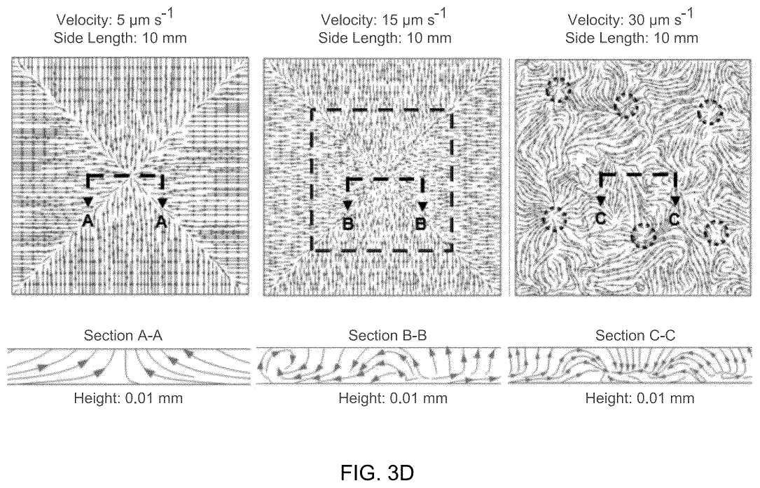

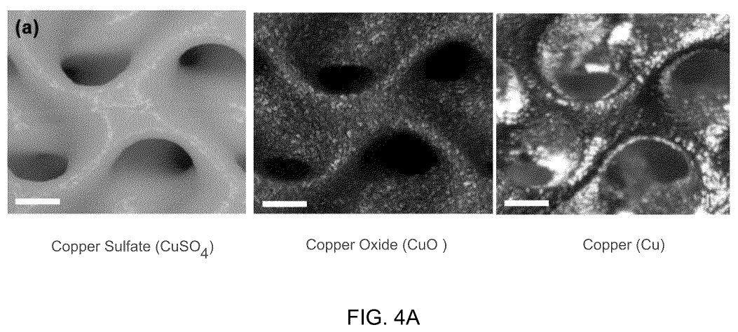

In the layer-less MVP-VPP process, an oxygen inhibition layer, which prevents photopolymerization upon incident light exposure, is formed through the diffusion of oxygen molecules from a thin film of polydimethylsiloxane (PDMS) into the resin which promotes the fabrication of 3D structures continuously. As illustrated in FIG. 3A, as the build platform moves with a constant vertical velocity V_{z}, the cured metal precursor structure, with square side length L, is elevated above the oxygen inhibition layer by a small gap distance h. Based on previous work, resin refilling within the video projection area is primarily driven by the positive pressure gradient between the ambient air pressure and void left from the cured part coupled with the effect of gravity on microparticles embedded within the resin. During liquid refilling, it is assumed that the surface boundary of the oxygen inhibition layer and the cured structure are both parallel, with respect to each other, and remain unperturbed during both resin filling and solidification processes for the entire printing duration. Furthermore, the resin flow during printing is assumed to be laminar, steady, and fully developed. Consequently, the velocity profile can be characterized as Hele-Shaw flow by Equation 2 where VR is the velocity of the resin, Δp is the local pressure gradient, z is the spatial coordinate in the z-direction, and u is the viscosity of the liquid resin.

$${V}_{R} = \frac{Δ p}{μ L} [ {( \frac{h}{2} )}^{2} - {( z - \frac{h}{2} )}^{2} ] \qquad Eq . 2$$

Although the velocity determined through Equation 2 is adequate in characterizing the localized resin refilling dynamics during the layer-less fabrication process, it neglects the monomer cross-linking reaction engendered from incident light exposure on the resin surface. During continuous mask video projection 3D printing, as metal salt resin recoats the projection area the viscosity increases substantially during cross-linking of monomer constituents. Therefore, Equation 2 can be modified to incorporate the exponential decay of viscosity due to the photopolymerization process during liquid refilling, as shown in Equation 3, where α is a non-zero constant if light energy is absorbed by the metal sulfate resin.

$${V}_{R} = \frac{Δ p}{μ L} {e}^{- α} [ {( \frac{h}{2} )}^{2} - {( z - \frac{h}{2} )}^{2} ] \qquad Eq . 3$$

Equation 3 reveals that mean resin refilling speed increases with smaller side lengths, lower viscosity printing resins, and larger oxygen inhibition regions during the MVP-VPP process allowing for faster printing times. Conversely, the refilling velocity will decrease dramatically for resins with high viscosity and low energy absorption from light scattering effects. Moreover, resins used during MVP-VPP require excellent dispersion of metal salt particles to prevent premature hydration and aid in transporting a sufficient amount of the solid phase to the fabrication area by the liquid phase. Consequently, the valid side length of 3D structures fabricated through MVP-VPP process is limited to microscale features. Thus, in order to increase the mean resin refilling and printing speed, the height of the oxygen inhibition zone can be increased, exceeding previous reported values of 100 μm, while simultaneously integrating low viscosity printing materials with superior dispersion to allow for larger fabrication areas during printing.

To generate an accurate model that characterizes the relationship between liquid refilling and maximum fabrication area, the volumetric flow rate of metal salt resin to the fabrication area during the MVP-VPP process is studied. As the cured structure is continuously lifted, the volumetric flow rate Q under a square cross-section with area L² can be described by Equation 4 utilizing the same assumptions for resin flow described above.

$$Q = {\int }_{0}^{L} dx {\int }_{0}^{h} \frac{Δ p}{μ L} {e}^{- α} [ {( \frac{h}{2} )}^{2} - {( z - \frac{h}{2} )}^{2} ] dz \qquad Eq . 4$$

Since the printing platform is moving with constant velocity V_{z}, the total volume under the cured part, after time increment Δt, may be sufficiently filled with resin, and subsequently photopolymerized, to fabricate layer-less metal salt structures. Inadequate resin filling, for an arbitrary projection area A, may then be distinguishable by voids or channels in the final cured structure. Hence, the maximum side length Lₘₐₓ that can be printed for a given linear stage velocity using the MVP-VPP process is detailed in Equation 5 where K is a constant that encompasses contributions from the pressure gradient, oxygen inhibition layer height, and apparent viscosity of the resin.

$${L}_{max} = \frac{K}{\sqrt{{V}_{Z}}} {e}^{- α} \qquad Eq . 5$$

Accordingly, the theoretical model expressed in Equation 5 is refined through experimental testing of the resin refilling process to probe the relationship between printing speed V_{z} and maximum side length Lₘₐₓ. Based on curing characteristics described in previous sections, an array of squares with side lengths ranging from 0.8 mm to 2 mm, in 0.1 mm increments, are fabricated using the MVP-VPP process with different speed parameters. Successfully printed structures exhibit excellent surface roughness with no defects in contrast to defective printed structures which are distinguished by pore defects on the front and top faces of the cubic structure, see FIG. 3B. Printing speed is gradually increased from a baseline velocity of 5 μm s⁻¹ until the linear velocity parameters produced no successful printed parts. Experimental results are illustrated in FIG. 3C. with the theoretical model superimposed where the constants K and a are empirically determined through nonlinear curve fitting analysis with the constants equal to 3.2 and −0.4637, respectively. The theoretical model presented here can be employed to predict defects in the printed structure based on the cross-sectional area of the digital model where fabrication areas and velocities that lay underneath the theoretical model curve will result in sufficient resin filling during printing. Conversely, exceeding the theoretical model will increase the probability of micropore defects since the resin refilling and cross-linking mechanism is slow in comparison to the linear stage speed. Therefore, simulations of continuous resin flow are detailed below to investigate the mechanism of micropore formation.

In order to predict the influence of printing speed on the void defect at the bottom of the printed part, the computational fluid simulation module of COMSOL Multiphysics is used to uncover the mechanism of defect formation. The liquid filling process of continuous liquid interface printing is simplified as sheet liquid filling. In the setting of boundary conditions, the bottom surface of the printed sample that moves upwards is replaced by the fixed upper surface, and is set as a liquid outlet, while the four narrow sides of the thin plate are selected as inlets. Obviously, different lifting speeds correspond to different inlet fluid velocities. The simulation results show that the liquid filling streamline under the condition of low lifting speed is laminar flow, and the liquid carries the microparticles to uniformly and stably fill the void gap generated by continuous lifting, see FIG. 3D. When the lifting speed increases, the streamlines at the center of the thin plate gradually become unstable and excessively turbulent. When the lifting speed exceeds a certain threshold, the filling streamline is completely disordered, and the corresponding discontinuous homogeneous supply of particles and sudden changes in flow rate led to a significant increase in the probability of cavity defects, which is detrimental to controlling print quality and may be avoided.

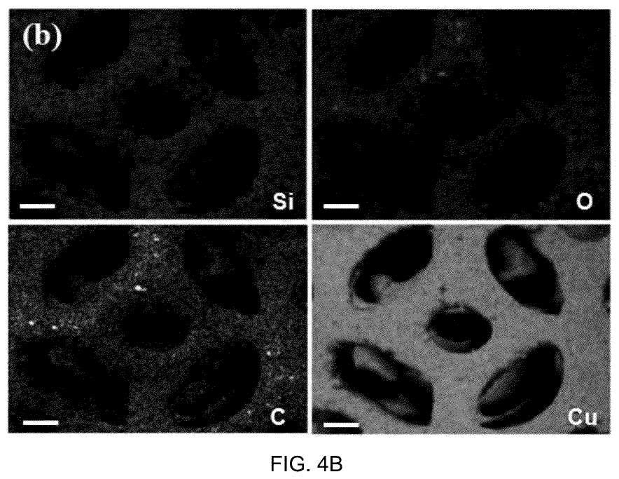

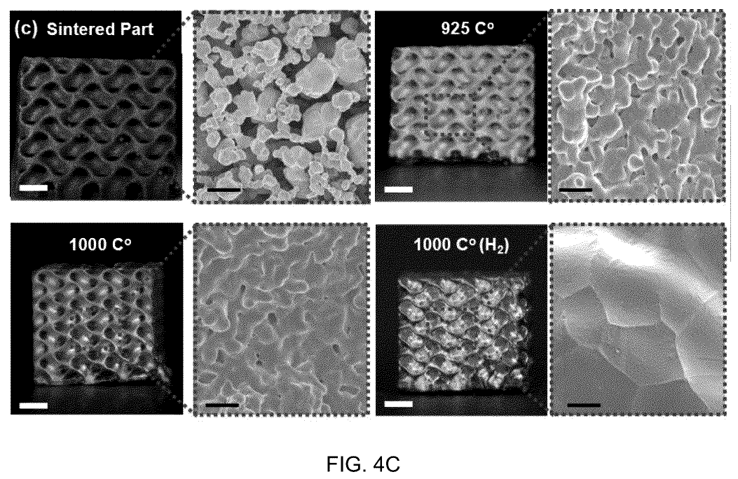

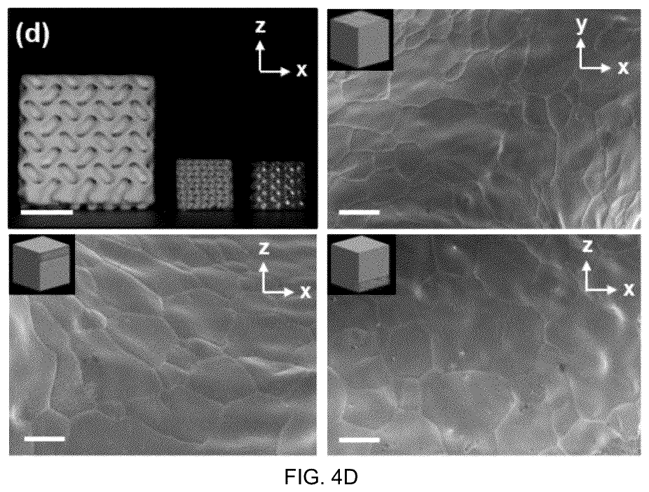

With the purpose of obtaining geometrically complex copper structures with excellent surface roughness, the influence of post-processing parameters, debinding, sintering, and thermal reduction, on the structural integrity of 3D printed green bodies fabricated via the MVP-VPP process are evaluated. In contrast to conventional DLP washing techniques that utilize volatile washing agents such as isopropyl alcohol (IPA), green bodies printed through the MVP-VPP process are hygroscopic and consequently are washed in a solution of HDDA to prevent swelling and surface defect formation before thermal processing. Green bodies that are ultrasonicated in HDDA maintain their morphology after washing and exhibit good surface roughness when compared to printed parts ultrasonicated in IPA that results in the swelling of the overall structure and poor surface roughness from the presence of CuSO₄ aggregates. Consequently, the 3D printed structures are dried under vacuum before post-processing to prevent hydration from the ambient atmosphere that may compromise the overall accuracy of the final metal component. As shown in FIG. 4A, mesoscale bioinspired gyroid structures with smooth features are achieved through stable thermal decomposition of green body specimens to form metal oxide structures which are then subsequently thermally reduced, under a reducing gas (5% H₂/95% Ar), to transform the metal oxide structures into a dense, monolithic metal component.

Optimization of debinding and sintering temperature profiles is conducted based on TGA results to reduce the decomposition rate of monomers, dispersant, and PI within the 3D printed green bodies. Three distinct regions exist where significant mass loss occurs: 100-200° C., 300-500° C., and 700-800° C. In the low temperature regions, dispersant and monomer constituents are decomposed and flushed out by the carrier gas, resulting in a mass loss of 56%, which is then followed by the thermal decomposition of sulfide from CuSO₄ to copper oxide (CuO) in the high temperature region further reducing the overall mass loss to 72%. Therefore, successful debinding, sintering, and thermal reduction of 3D printed green bodies using the MVP-VPP process may consider the thermal decomposition kinetics from dispersant and monomer removal, in addition to stable metal oxide synthesis, sintering, and reduction, in order to retain the surface quality of 3D printed metal objects.

During debinding and sintering, furnace temperature may be incrementally increased to prevent vigorous outgassing of dispersant and monomer constituents which can lead to the formation of macro-cracks in the CuO part. A constant flow of inert gas, during debinding, carries volatile, organic material from the surface of the 3D printed green body to reduce rapid thermal processes and promotes stable decomposition of CuSO₄ green bodies. Once the organic material is completely expelled, sintering is performed, in an oxidizing environment, to remove any residual carbon on the surface such that oxygen can react with CuSO₄ particles and easily convert the structure to metal oxide without compromising the surface integrity. Once the CuO part is obtained, the part is then placed in a reducing atmosphere to form the final Cu structure. In order to verify the composition of the final metal part, elemental mapping of a MVP-VPP printed octahedron pyramid evinces that the majority of the chemical composition is Cu with small contributions from C, Si, and O. Cu contributes 89.1% weight to the overall structure in comparison to other elements such as C and O which are around 10.1% and 0.6% weight, respectively. Although lighter elements are more difficult to analyze using EDS, the presence of C onto the final metal structure can be attributed to extrinsic carbon from handling the parts after post-processing. Therefore, SEM images and elemental mapping of metal structures exhibit good surface roughness and verified that the post-processing method can easily be utilized to make monolithic metal structures.

With the aim of obtaining homogeneous metal parts with high relative density, the influence of post-processing parameters, sintering and reduction temperatures on the final microstructure are studied. Firstly, the sintered metal oxide components provide mechanical strength to the part and demonstrate that layer-less ceramics can be achieved with good morphology and porosity after thermal processing, see FIG. 4C. SEM images of the Cu gyroid sintered at 925° C. and 1000° C. exhibit slightly different levels of porosity within the microstructure for the same reducing conditions. The Cu gyroid sintered at 1000° C. shows that the particles within the microstructure are more tightly packed together since the particles were densified at a higher temperature. Conversely, a high relative density microstructure, with uniform grain size, can be seen in Cu gyroid by simply increasing the H₂ reduction temperature to 1000° C. Because both the sintering and reduction temperature are increased, the final Cu gyroid displays well defined grain boundaries with no observable porosity. Furthermore, the luster seen in Cu gyroids increases for higher sintering and reduction temperatures since the gyroid at 925 has a slight orange hue in comparison to the 1000 gyroid which exhibits a pink hue. Additionally, higher reduction temperatures shift the luster of the Cu gyroid to a dark-orange hue; however, if the part is exposed to high temperatures and flow rate of H₂ for long dwell times, the onset of hydrogen embrittlement will deteriorate the Cu parts. This opens intriguing perspectives since the microstructure of the monolithic metal part can be controlled by adjusting the sintering and reduction temperature profiles.

At each stage of the thermal decomposition process, the MVP-VPP printed part maintains its morphology and surface quality, predefined by the mask image video during fabrication, by dispersant and polymer removal, metal oxide formation, sintering, and metal oxide reduction. During metal oxide formation and sintering, the feature size of the bioinspired gyroid design is reduced while annealing CuO particles and undergoes linearly shrinkage by ˜36% followed by another significant decrease in dimension after metal oxide reduction. After post-processing the overall linear shrinkage of the bioinspired gyroid lattice is approximately ˜59%, as shown in FIG. 4D. Consequently, high dimensional control can be achieved, considering the uniform shrinkage during the design and fabrication phase, to obtain geometrically complex metal structures with microscale feature sizes that significantly exceed the printing resolution of the MVP-VPP printer. Furthermore, SEM images of the front and top side of the gyroid lattice display uniform grain distribution, with high relatively density throughout the microstructure, indicating that metal structures printed via MVP-VPP are monolithic and homogeneous. Additionally, the surface quality is significantly improved, in comparison to layer-based AM approaches, with no observable staircasing effect. Therefore, these results are highly advantageous since it suggests that metal parts fabricated via the MVP-VPP process have isotropic physical properties which can significantly enhance the performance of 3D printed functional metal devices.

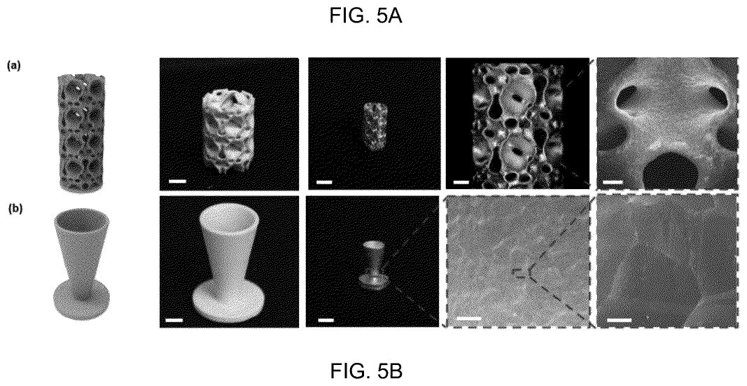

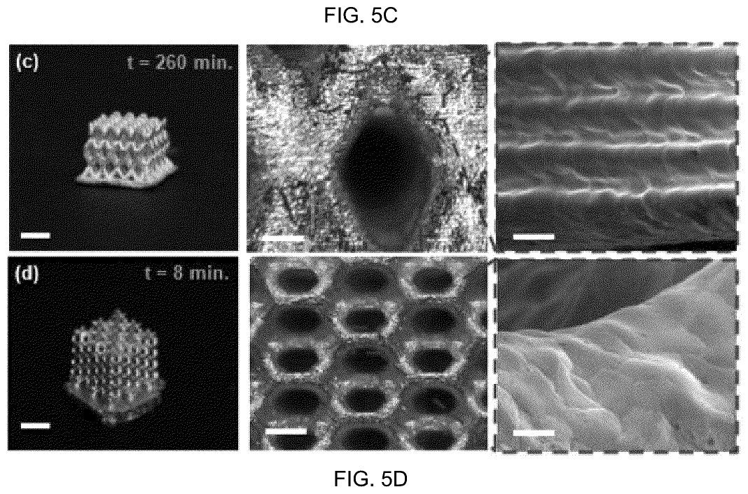

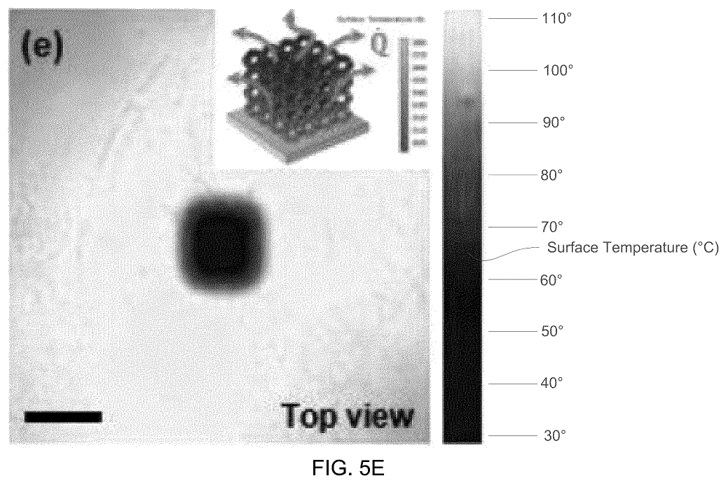

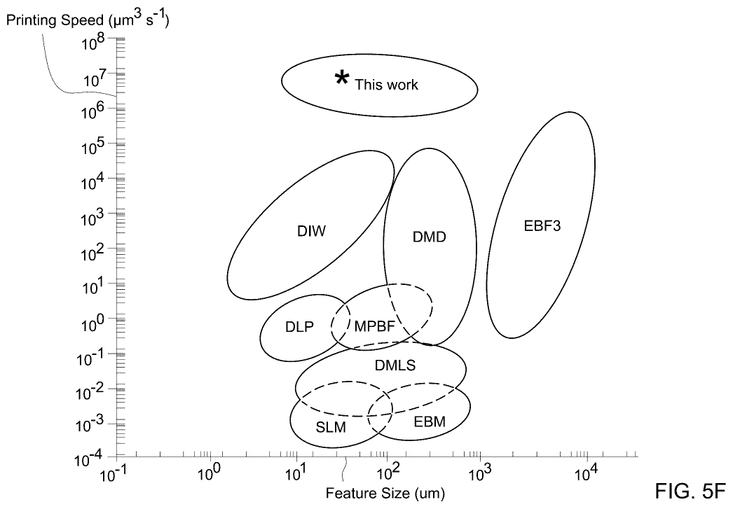

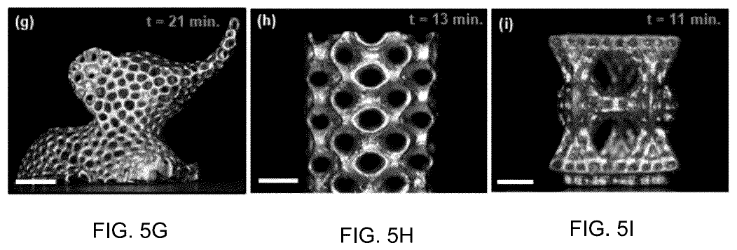

Fundamentally different from traditional layer-based metal 3D printing technologies, the MVP-VPP process has the ability to fabricate sophisticated and unique functional metal devices, within a matter of minutes, with improved physical performance and excellent surface roughness that can be useful for both electrical and thermal applications. Metal salt resin with 62% (w/w) solid loading are utilized to fabricate the digital models. FIG. 5A shows an intricately designed heat sink fabricated through the MVP-VPP process before and after thermal post-processing. It can be observed that even for cylindrical or columnar structures the overall morphology is maintained, and shrinkage is uniform throughout the entire part. Furthermore, SEM images show that the Cu heat sink has an extremely smooth surface finish, with minimal layer adhesion between adjacent layers, which can lead to more homogeneous thermal conduction and more efficient heat dissipation. Additionally, the Cu structures are mechanically robust and can withstand compression force upwards of 1 kN without failure demonstrating ductile behavior. Similarly, a conical horn antenna (FIG. 5B) is designed and fabricated through the MVP-VPP process and exhibits a dense microstructure, with smooth surface roughness, as depicted in SEM images. The high density, uniform distribution of grains, and superior surface roughness are necessary for robust antenna design applications that require strict design tolerances to minimize electrical loss and optimize the transmission signal for a designated frequency range. In comparison to traditional metal AM methods, the overall print times and cost are significantly improved which enables the rapid prototyping and iterative design of next-generation thermal and electrical devices with microscale resolution.

In order to assess the speed and physical performance of metal parts fabricated via the MVP-VPP process, the printing times and microstructure of a layer-based and layer-less 3D printed heat sink are compared. As shown in FIG. 5C, a lattice heat sink, with X-type unit cell of dimensions 1 mm×1 mm×2.5 mm, requires a total printing time of 260 minutes, using 20-micron slicing, to obtain the metal precursor structure. Moreover, microscopic images of the surface quality demonstrate that even at high slicing resolution the layer-effect from curing a single layer is clearly visible which drastically impacts the surface quality of the final metal part. SEM images further evince that layer-based printing approaches inherently result in dense microstructures, similar to the layer-less AM approach, however the bonding between individual layers results in anisotropic physical properties since the metal part is heterogeneous and is composed of hundreds of layers that must translate physical information between each layer. Conversely, a layer-less lattice heat sink, with Kelvin unit cell, exhibits significantly improved surface roughness when compared with the layer-based X-type lattice and the printing speed is substantially reduced to 8 minutes which is a 97% decrease in fabrication time, see FIG. 5D. Since the heat sink is printed continuously, the printing platform does not require prolonged idle time during light exposure and resin recoating which contribute significantly to the overall time required to print the digital model. Therefore, thermal management systems printed through the MVP-VPP process therefore are more advantageous since the thermal properties of a particular design can be rapidly fabricated and tested in a short amount of time without the need for expensive manufacturing equipment and material. Thermal characterization of the layer-less Kelvin heat sink was conducted utilizing COMSOL Multiphysics and experimental testing to determine the heat dissipation capabilities of the 3D printed heat sink. The simulation and experimental boundary condition of T=110° C. is imposed on the bottom plate of the heat sink and the environmental conditions of the air are 25° C. The thermal distribution of the 3D printed heat sink is shown in FIG. 5E and illustrates that the metal structure is thermal conductive and highly efficient with the lowest recorded temperature being approximately 40° C. Moreover, the front view of the IR images further reveals that the heat dissipation at the outer boundary of the Kelvin heat sink is broader than the top view with a distinctive layer of hot, warm air surrounding the structure. This aligns with thermal simulation results of the digital model shown within the inset of FIG. 5E. Consequently, the MVP-VPP technology can be extended to multiple thermal management systems for optimally designed industrial applications with high resolution.

Conventional metal AM technologies employ various methods in order to supply the necessary energy to form the desired 3D metal objects from raw material such as jetting binder material, laser and electron deposition, and material extrusion layer-by-layer. Because the achievable feature size and build time are closely correlated to the energy deposition method, the overall printing speed of traditional metal AM is compared with the MVP-VPP process. In this work, the layer-less AM process is capable of achieving printing speeds exceeding 10⁷ μm³ s⁻¹ for a feature size of 100 μm in contrast to both energy and material deposition methodologies. For example, selective laser melting (SLM), direct metal laser sintering (DMLS), electron beam melting (EBM), and metal powder bed fusion (MPBF) can fabricate 3D metal objects with a similar range of minimum feature size (10-1,000 μm), however since the energy deposition tool must trace the tool path for an entire layer, the printing speed is dramatically decreasing below 100 μm³ s⁻¹, see FIG. 5F. The same trend can be seen for material extrusion methods, such as direct ink writing (DIW), direct metal deposition (DMD), and freeform electron beam fabrication (EBF3). The printing speed is significantly improved by the linear printing speed of the printing nozzle, since material is directly deposited onto the build platform, to form an individual layer, but consequently the build time is limited by the predefined tool path. Utilizing the described MVP-VPP approach, a Voronoi elephant (FIG. 5G), primitive columnar structure (FIG. 5H), and kagome tower (FIG. 51) can be fabricated in 21 minutes, 13 minutes, and 11 minutes, respectively. In order to acquire the same surface roughness and resolution using traditional metal printers the printing speed would be substantially reduced since each layer must be cured individually. Therefore, because each metal structure is fabricated through a continuous layer-less AM approach, the print times for microscale resolution metal parts is largely enhanced.

Pre-Processing of Anhydrous Metal Sulfate: In order to achieve a high concentration of metal sulfate particles within the polymer matrix, copper sulfate pentahydrate (≥98.0%, Sigma Aldrich) was first dehydrated to form anhydrous copper sulfate (CuSO₄). Dehydration was performed using a high temperature muffle furnace (MTI KSL-1700X, MTI Corp.) and alumina crucibles with a ramping rate of 5° C. min⁻¹, target temperature of 400° C., and a dwell time of 5 hours. After furnace cooling, the mass of the resulting powder was ascertained by a high precision balance to verify water molecules were adequately removed from the raw material based on thermogravimetric data. Anhydrous metal sulfate powder with particle size distribution less than 100 microns was achieved by sieving dry milled metal sulfate through a 0.1 mm metal mesh (TITAN) before being used as the filler material.

Preparation of Metal Sulfate Resin: Organic monomers 1,6-Hexanediol diacrylate (HDDA) (80%, Sigma-Aldrich) and trimethylolpropane ethoxylate triacrylate M_{N}=428 (E-TMPTA) (Sigma-Aldrich) were mixed utilizing a mass-to-mass ratio of 22 to 3, respectively, with different weight percentages of PI (Omnirad 819, IGM) for a minimum of 3 hours using a magnetic stirrer. To improve the curing performance and rheological properties of the metal salt resin, the dispersant Triton X-100 (TX-100) (Sigma-Aldrich) was added to the solution and allowed to homogenize for 1 hour. The anhydrous metal salt powder was then batchwise added to the photocurable resin and dispersant solution in a stainless-steel milling jar with zirconia milling balls at a speed of 300 RPM overnight using a planetary ball mill machine (MTI MSK-SFM-1). The mass of anhydrous metal salt was adjusted to produce photocurable metal salt bearing resins with weight percentages ranging from 40%-67%.

Video Construction: Utilizing STL slicing software, digital models were imported and centered on the printing platform before being converted into a collection of grayscale mask images that each represented a cross-sectional area of the overall structure. Grayscale images were then processed through a video editor (VirtualDub64) to construct a mask image video of the digital model where the frame rate, represented in frames per second (fps), was tuned to synchronize with the linear motion of the build platform during the printing process determined by Equation 6. A conservative slicing thickness of 5 microns was utilized for the fabrication of all digital models in order to improve surface roughness.

$$fps = \frac{printing speed}{slicing thickness} \qquad Eq . 6$$

Fabrication of Metal Salt Precursors: In the MVP-VPP process, photosensitive metal salt resin continuously recoated the projection area in a transparent, PDMS-coated glass resin tank as the printing platform elevated at a constant velocity. As the printing platform continuously moved upward, each cross-sectional area of the target object was selectively cured forming a solid body, above the boundary of the oxygen inhibition region, when a 2D patterned light source was projected by the optical system onto the bottom of the glass tank. To project the mask image video as a 2D light beam, a 405 nm wavelength light was reflected by a digital micromirror device (DMD), composed of an array of 1920×1080 micromirrors, and focused by a convex lens (Thorlabs Inc.) with a focus distance f=150 mm. Cross-linking characteristics of metal salt resins were performed by solidifying thin films (2 mm×2 mm) which were subsequently measured using high-precision calipers (EAGems Digital Caliper) to determined cure depths and exposure times for the purpose of setting printing parameters. To study the influence of printing speed on maximum allowable side length, a digital model composed of an array of squares, with lengths ranging from 0.8 to 2 mm, was generated using SolidWorks and converted into a mask projection video (described above). The printing speed of the MVP-VPP process was adjusted based on the photosensitivity and rheological properties of the metal salt material to improve dimensional accuracy and surface finish of 3D printed green bodies. Green bodies printed through the MVP-VPP process were washed in HDDA for 15 minutes using an ultrasonicator and dried under vacuum for 1 hour. Printed structures were then fully cured by prolonged exposure to a UV lamp to promote crosslinking of residual uncured resin on the surface of the green body.

Rheological Measurements: Viscosity experiments of the metal salt resins were performed at room temperature using a rheometer (Discovery HR 30) to analyze the rheological behavior of the material. Steady-state shear rate sweep, from 10 to 100 s⁻¹, was conducted on the resin, with varying concentration of anhydrous metal salt and dispersant, directly after wet milling. With the purpose of preventing solidification of metal sulfate resin during testing, photoinitator was intentionally omitted during material preparation.

Thermogravimetric Analysis: Thermogravimetric analysis (TGA) was conducted on cubic green body samples using a simultaneous temperature analyzer (LABSYS evo) utilizing a target temperature of 1000° C. with a ramping rate of 5° C. min⁻¹ under an air atmosphere. The derivative of mass loss (DTG) was then calculated from TGA data and used to generate debinding and sintering curves for thermal post-processing based on inflection points.

The laminar flow module of COMSOL Multiphysics is used to analyze the refilling process of liquid and particle mixture during MVP-VPP printing. By observing the process of printing a constant-section (10 mm×10 mm) structure, the process of fluid refilling is simplified to a thin plate with a filling gap of 0.1 mm, the top of the thin plate is an outlet, the pressure is 0 Pa, and the flow velocity of the inlets on the four sides is determined by the lifting speed. Streamlines in simulation results reveal liquid and particle refilling states and locations of potential cavity defects.

Metal structures were obtained from TGA-assisted thermal processing that included three steps: debinding, sintering, and thermal reduction of the 3D printed green bodies using the MVP-VPP process. Debinding was performed in a tube furnace, under inert atmosphere, utilizing a conservative ramping rate of 1° C. min⁻¹, with dwell temperatures of 215° C., 360° C., 415° C., and 600° C. for 2 hours. The samples were then placed in a muffle furnace and thermally decomposed to metal oxide in alumina crucibles in air at dwell temperatures of 705° C. and 785° C. for 2 hours. Afterwards, the temperature was increased further to reduce porosity via sintering of the samples under different temperature conditions of 850° C., 925° C., and 1,000° C. for 5 hours. The resulting metal oxide structures are then thermally reduced in a tube furnace to metal under 5% H₂/Ar atmosphere at a temperature of 800° C. for 10 hours using a ramping rate of 3° C. min⁻¹.

Mechanical properties of metal lattice structures fabricated via the MVP-VPP process were evaluated using a universal testing machine (Instron 5492 Dual Column Testing Systems). Cubic lattice compression specimens (i.e., gyroid pattern) were tested by continuously increasing the applied force at a constant rate of 0.2 mm min⁻¹ until maximum load was achieved (n=4 samples). Heat dissipation of metal structures fabricated using the MVP-VPP process was demonstrated by heating the base of a 3D printed heat sink to 110° C. on a hot plate. Infrared videography (FLIR ONE Gen 3) was then utilized to observe the temperature distribution and heat dissipation throughout the lattice structure during the experiment. COMSOL Multiphysics was utilized to analyze the thermal distribution in the digital lattice models for comparison with laboratory experiments using a boundary condition of 110° C. on bottom plate.

Accordingly, the present disclosure demonstrates a novel cost-effective layer-less AM technology for fabricating high relative density and homogeneous metal objects with significantly improved printing speeds and surface quality when compared with traditional metal AM methods. Printed metal salts can be readily dispersed into monomer and dispersant photocurable solution to achieve low viscosity printing inks with good printability. The low viscosity and homogeneous distribution of metal salt, which serves as the metal precursor, aids in the layer-less fabrication of complex metal precursor structures since the liquid phase can adequately carry microparticles to the fabrication area. Furthermore, since the part is printed continuously, through projection of a high-frame rate video constructed from the digital model, the surface quality is significantly enhanced from layer-based image projection technologies without a conspicuous staircasing effect. The printing speed and minimum feature size for the newly developed MVP-VPP process was compared and can achieve a speed 5-8 orders of magnitude faster than traditional metal AM methods.

Additive manufacturing (AM) has recently become an ideal technology for fabricating high-quality metal components to address emerging research challenges in aerospace and automotive fields. For example, metal 3D printing methods, such as selective laser sintering and powder bed fusion, enables the ability to design and print intricate metal structures that are difficult to reproduce using traditional manufacturing methods. However, current metal AM technologies are limited by long print times and lack microscale dimensional control from rapid heating and cooling processes. Moreover, digital light processing (DLP) 3D printing, a layer-based printing process, has been demonstrated to be a viable approach, using oxidation and reduction reactions of inorganic metal salt precursors, to fabricate 3D metals and alloys, with microscale resolution. But drawbacks associated with “staircasing effects”, that lead to heterogeneous behavior in the overall structure, can reduce the performance of functional 3D printed metal parts. Hence, the presented work focuses on developing an ultra-fast layer-less AM process to fabricate complex and homogeneous 3D metal structures, with tunable physical properties and good surface quality, using continuous mask video projection based photopolymerization. Based on experimental and simulation data, high relative density meso- and microscale metallic parts can be printed via the metal mask video-projection vat photopolymerization (MMVP-VPP) process orders of magnitude faster than commercial metal AM technologies. Moreover, the metallic parts have homogeneous morphology and microstructure with uniform grain sizes exhibited on front, top, and bottom faces of bioinspired lattice structures. Finally, the surface roughness and smallest feature size of layer-based and layer-less metal printed structures are compared and the broad impacts on industries and academic applications are elucidated.

Metal additive manufacturing (AM), also known as metal three-dimensional (3D) printing, demonstrates the ability to fabricate geometrically intricate and unique metal and metal alloy objects, with feature sizes ranging from macro to nanoscale structures, when compared to traditional manufacturing technologies. The design flexibility and material selection provided by AM technologies enables the fabrication of low-cost, high resolution metal components with excellent physical properties for use in automotive, aerospace, and biomedical industries. For example, selective laser melting (SLM) and powder bed fusion (PBF) technologies exhibit the capability to fabricate high strength, impact resistant metal 3D objects, with bioinspired lattice structures, which can withstand extreme thermal environments under high mechanical loading. Furthermore, recent advancements in extrusion- and energy deposition-based metal rapid prototyping technologies show that functional graded materials, such as electrodes and heat exchangers, with excellent electrical and thermal conductivity can be manufactured with relative case allowing for rapid and efficient topologically optimized designs via machine learning. Currently, metal AM technologies can be classified into two discrete regimes based primarily on how the digital model is converted into a physical structure by the deposition of material along a predetermined tool path. Material deposition techniques, such as electron beam melting (EBM) and direct ink writing (DIW), trace a computer-generated tool path to form the metal structures layer-by-layer while simultaneous material deposition processes, such as metal binder jetting (MBJ), employ a selectively controlled surface energy and material deposition tools to construct a single layer instantaneously. However, since the 3D metal structure is constructed layer-by-layer, a conspicuous “staircasing effect”, related to the layer thickness resolution used to generate the tool path or 2D mask images, significantly influences the surface roughness of the manufactured part which can lead to detrimental effects on the desired functionality. High surface quality metal structures are imperative for applications in electronic devices, optical components, and aerodynamic structures, which impose strict tolerances on surface roughness, where required for adequate performance of the metal part. Moreover, challenges associated with obtaining excellent layer adhesion, using traditional layer-based metal printing technologies, promotes anisotropic behavior of the metal structure, from non-homogeneous physical properties observed in individual layers, which compromises thermal, electrical, and mechanical properties.

Recent developments in AM technologies that utilize vat photopolymerization (VPP), a method that integrates a 2D light beam to solidify selective areas of a photocurable liquid resin layer-by-layer, makes significant improvements in both fabrication speed and surface quality of 3D printed metal, ceramic, and polymer composite structures. Direct light processing (DLP) and stereolithography (SLA), two types of vat photopolymerization techniques, currently demonstrate the ability to manufacture high temperature refractory metals and multi-material structures for high performance electrodes with good surface quality and greater resolution when compared with laser energy deposition approaches. However, ceramics and metals printed via DLP and SLA have limited material selection and exhibit anisotropic thermal and mechanical behavior which can facilitate the formation of defects and microcracks during post-processing. Conversely, continuous liquid interface production (CLIP) is a layer-less AM approach that implements an oxygen rich dead zone and 2D light projection to fabricate homogeneous 3D object with smooth surface features. Since photocurable material continuously refills the fabrication area within the thin oxygen inhibition region, the CLIP process can achieve printing speeds substantially greater than layer-based AM technologies with excellent dimensional accuracy and small feature size. Although significant advancements have been made in improving the resin recoating mechanism and increasing the height of the oxygen inhibition region, there exists several limitations on the continuous printing process. One of the more prominent constraints is that continuous layer-less AM processes require low viscosity printing inks, to promote adequate recoating of photocurable material, to attain fast build times. However, in order to achieve dense metallic objects, a high solid loading content of metal precursor powders to a polymer matrix which consequently increases the viscosity of the material, while simultaneously decreasing the light penetration depth and photosensitivity of the material, making it incompatible with layer-less AM processes. Furthermore, the CLIP process can only fabricate small cross-sectional areas since the resin refilling rate is limited by the pressure gradient between the void and surrounding resin. Therefore, challenges of incorporating a metal precursor powder to obtain a low viscosity printing ink for the layer-less fabrication of metallic objects remains to be addressed.

Inorganic metal salts, as a metal precursor additive, show promising rheological properties and steric stability when combined with low viscosity acrylic-based resins for metal VPP and DLP technologies. Metal salts are predominantly low-cost and can be incorporated into photocurable slurries, with excellent refractive indices, high solid content, and particle dispersion, allowing for the rapid fabrication of robust, high-resolution metal structures, via subsequent oxidation and reduction post-processing methods, for a broad range of metals and alloys. Furthermore, inorganic metal salts show great advantages for the fabrication of homogeneous metal-doped polymer derived ceramics via DLP with high dimensional accuracy. Besides, the methodology for manufacturing metal oxide and metallic structures via metal salt precursors is extraordinarily sustainable. Base metal salt precursor material can be easily synthesized from metal oxide and metallic structures, using rudimentary acid metal chemical reactions, and repurposed for the fabrication of a new metallic part which provides new perspectives on the iterative design of metal 3D printed structures. In contrast to conventional metal precursors, microscale hydrogel scaffolds demonstrate the capability to fabricate metal and multimetal components, in parallel, through ionic diffusion into the polymeric matrix. This significantly cases challenges associated with optimizing resin formulations and printing parameters for individual slurries since only the solvent needs to be changed for different metals and alloys. However, since the hydrogel structure must be immersed in a metal solvent to promote the exchange of metal ions, constructing geometrically complex and intricately patterned multimetal structures remains an issue. Furthermore, the aforementioned metal DLP techniques are layer-based approaches which evinces reduced surface quality at microscales and nonhomogeneous physical properties from weak interface adhesion between adjacent layers.

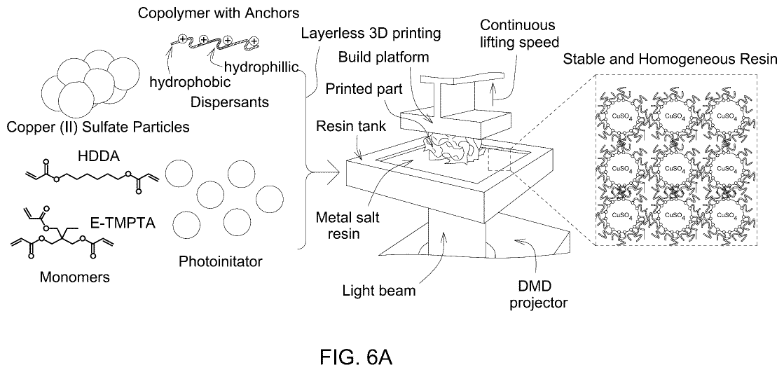

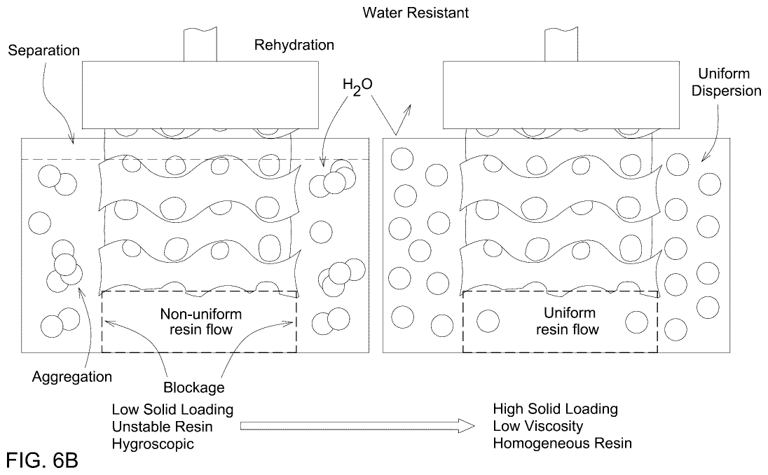

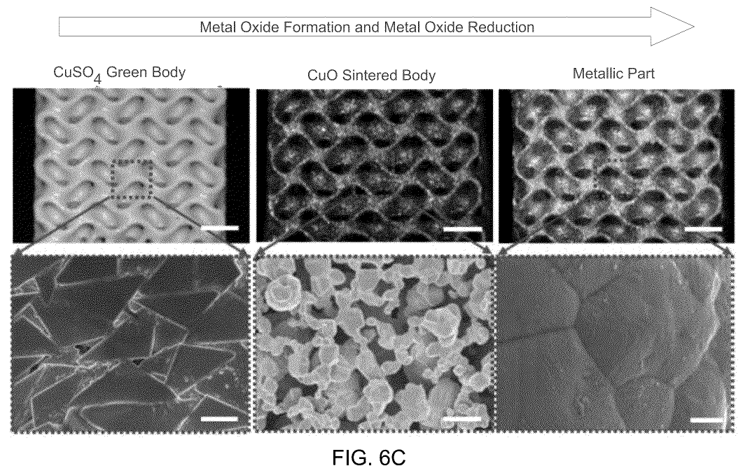

In this work, a novel low-cost and layer-less metal AM process to rapidly fabricate high resolution 3D metallic structures with homogeneous, isotropic physical properties and smooth surface finish is presented. As depicted in FIG. 6A, the metal mask video projection-based vat photopolymerization (MMVP-VPP) process circumvents material and printing speed limitations of current metal AM technologies by integrating a low viscosity metal salt precursor resin (see FIG. 6B) and high frame rate video, generated from the digital model, that uniformly deposits and crosslinks new material in the projection area promoting the continuous fabrication of 3D metallic objects. Firstly, curing characterization and rheological behavior is investigated to ascertain nominal fabrication speeds based on mean resin refilling and photopolymerization mechanisms. Optimized post-processing parameters, guided through thermogravimetric analysis (TGA) of printed metal salt green bodies, are evaluated with the purpose of efficiently converting the printed structure into the desired metallic structure via debinding, sintering, and thermal reduction (see FIG. 6C). Based on experimental results, the MMVP-VPP process demonstrates the ability to fabricate dense, homogenous metal objects at fast printing speed, upwards of 10⁷ μm³ s⁻¹, that exhibit drastically improved surface roughness compared with traditional layer-based metal AM processes. Moreover, unprocessed materials are cost effective, easily procurable, and readily recyclable which make this an ideal AM method for the design of sustainable, next-generation functional metal devices with isotropic physical properties. Current limitations associated with the MMVP-VPP process are elucidated in further detail in order to promote future research to address these challenges.

In order to achieve a high concentration of metal sulfate particles within the polymer matrix, copper sulfate pentahydrate (≥98.0%, Sigma Aldrich) is first dehydrated to form anhydrous copper sulfate (CuSO₄). Dehydration is performed using a high temperature muffle furnace (MTI KSL-1700X, MTI Corp.) and alumina crucibles with a ramping rate of 5° C. min⁻¹, target temperature of 400° C., and a dwell time of 5 hours. After furnace cooling, the mass of the resulting powder is ascertained by a high precision balance to verify water molecules are adequately removed from the raw material based on thermogravimetric data. Anhydrous metal sulfate powder with particle size distribution less than 100 microns is achieved by sieving dry milled metal sulfate powder through a 0.1 mm metal mesh (TITAN) before being used as the filler material.

Organic monomers 1,6-Hexanediol diacrylate (HDDA) (80%, Sigma-Aldrich) and trimethylolpropane ethoxylate triacrylate M_{N}=428 (E-TMPTA) (Sigma-Aldrich) are mixed utilizing a mass-to-mass ratio of 22 to 3, respectively, with different weight percentages of photoinitator (Omnirad 819, IGM) for a minimum of 3 hours using a magnetic stirrer. To improve the curing performance and rheological properties of the metal sulfate resin, the dispersant Triton X-100 (TX-100) (Sigma-Aldrich) is added to the solution and allowed to homogenize for 1 hour. The anhydrous metal sulfate powder is then batchwise added to the resin and dispersant solution in a stainless-steel milling jar with zirconia milling balls at a speed of 300 RPM overnight using a planetary ball mill machine (MTI MSK-SFM-1). The mass of anhydrous metal sulfate is adjusted to produce photocurable metal sulfate bearing resins with weight percentages ranging from 40%-62%.

Utilizing STL slicing software, digital models are imported and centered on the printing platform before being converted into a collection of grayscale mask images that each represent a cross-sectional area of the overall structure. Grayscale images are then processed through a video editor (VirtualDub64) to construct a mask image video of the digital model where the frame rate, represented here in frames per second (fps), is tuned to synchronize with the linear motion of the build platform during the printing process determined by Equation 6. In this work, a conservative slicing thickness of 5 microns is utilized for the fabrication of all digital models in order to improve surface roughness.

In the MMVP-VPP process, photosensitive metal sulfate resin continuously recoats the projection area in a transparent, PDMS-coated glass resin tank as the printing platform elevates at a constant velocity, see FIG. 1. As the printing platform continuously moves upwards, each cross-sectional area of the target object is selectively cured forming a solid body, above the boundary of the oxygen inhibition region, when a 2D patterned light source is projected by the optical system onto the bottom of the glass tank. To project the mask image video as a 2D light beam, a 405 nm wavelength light is reflected by a digital micromirror device (DMD), composed of an array of 1920×1080 micromirrors, and focused by a convex lens (Thorlabs Inc.) with a focus distance f=150 mm. The printing speed of the MMVP-VPP process is adjusted based on the photosensitivity and rheological properties of the metal sulfate material to improve dimensional accuracy and surface finish of 3D printed green bodies. Green bodies printed through the MVP-MSL process are washed in HDDA for 15 minutes using an ultrasonicator and dried under vacuum for 1 hour. Printed structures are then fully cured by employing a UV lamp to promote crosslinking of residual uncured resin on the surface of the green body.

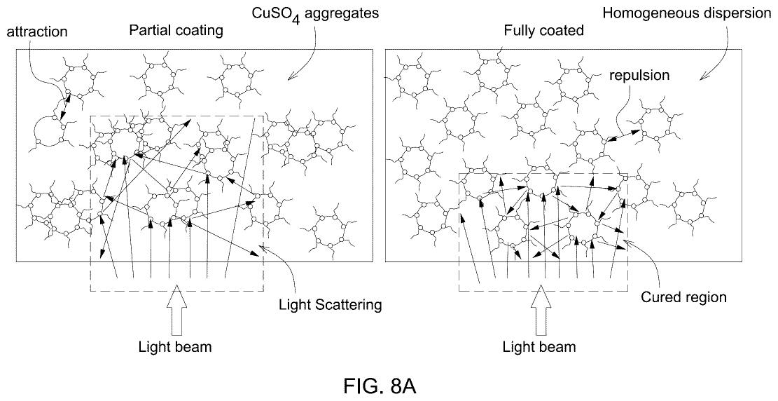

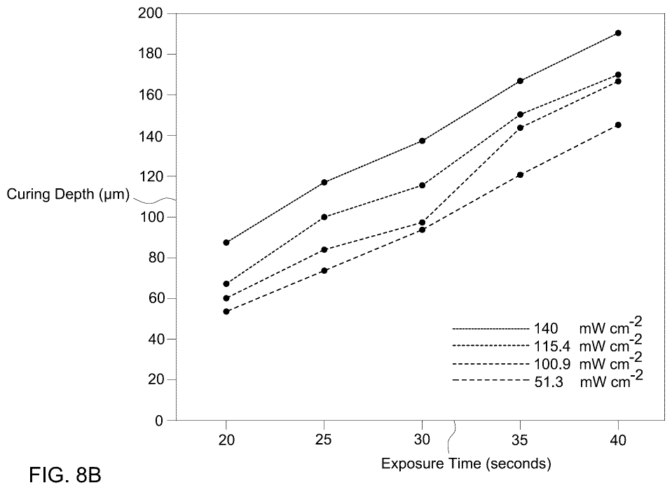

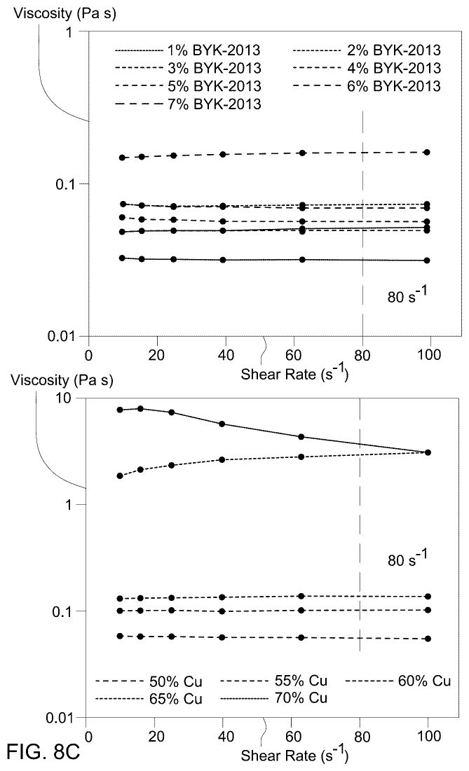

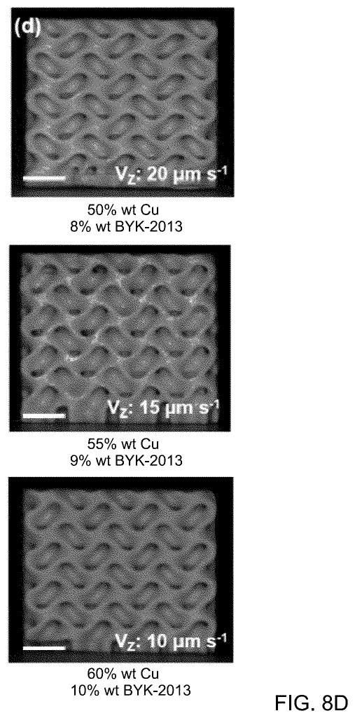

Viscosity experiments of the metal sulfate resin are performed at room temperature using a rheometer (Discovery HR 30) to analyze the rheological behavior of the material to assess compatibility with the MMVP-VPP process. Steady-state shear rate sweep, from 10 to 100 s⁻¹, is conducted on the resin, with varying concentration of anhydrous metal sulfate and dispersant, directly after wet milling, see FIG. 8C. Apparent viscosity With the purpose of preventing solidification of metal sulfate resin during testing, photoinitator is intentionally omitted during material preparation.

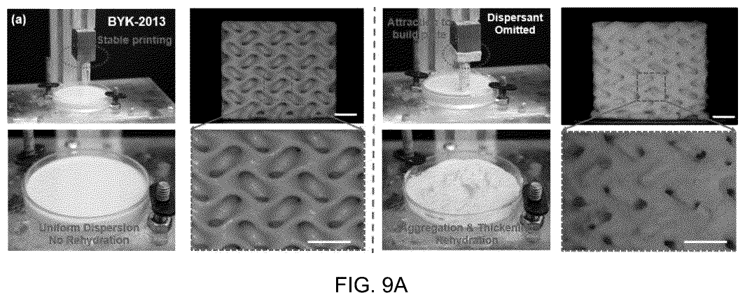

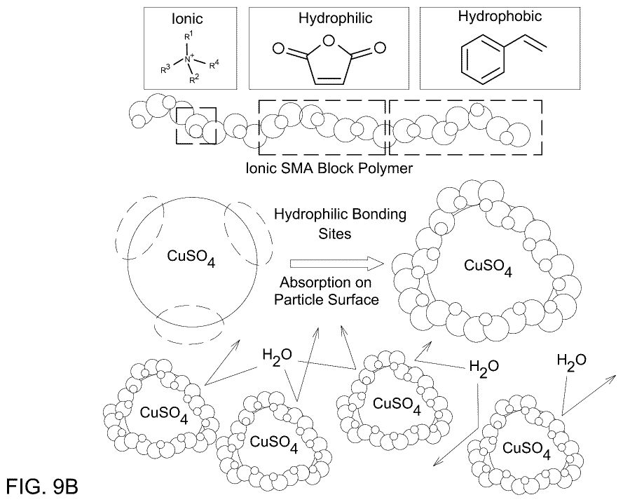

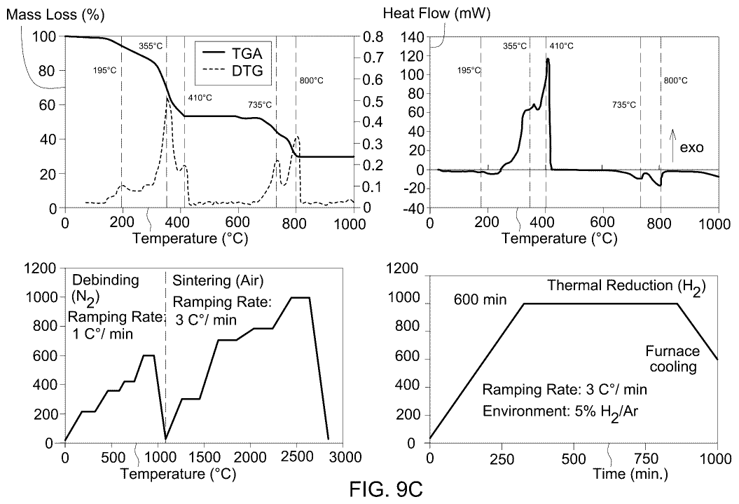

Thermogravimetric analysis (TGA) is conducted on cubic green body samples using a simultaneous temperature analyzer (LABSYS evo) utilizing a target temperature of 1000° C. with a ramping rate of 5° C. min⁻¹ under an air atmosphere. The derivative of mass loss (DTG) is then calculated from TGA data and used to generate debinding and sintering curves for thermal post-processing based on inflection points, see FIG. 9C.

Metal and metal oxide structures are obtained from TGA-assisted thermal processing that consists of three steps: debinding, sintering, and thermal reduction of the 3D printed green bodies using the MMVP-VPP process, see FIG. 9C. Debinding is performed in a tube furnace, under flowing ultra-high purity N₂ gas, utilizing a conservative ramping rate of 1° C. min⁻¹. with dwell temperatures of 215° C., 360° C., 415° C., and 600° C. for 2 hours. The samples are then placed in a muffle furnace and thermally decomposed to metal oxide, in alumina crucibles with lids, in air at dwell temperatures of 705° C. and 785° C. for 2 hours. Afterwards, the temperature is increased further to reduce porosity of the samples using a target temperature of 1000° C. for 5 hours. The resulting metal oxide structures are then thermally reduced in a tube furnace to metal under 5% H₂/Ar atmosphere at a temperature of 1000° C. for 10 hours using a ramping rate of 3° C. min⁻¹. The flow of gas for debinding and reduction may be within the range of 100-200 cc min⁻¹ for adequate results.

To generate a stable printing resin that can maintain homogenous dispersion of metal salt precursors, an ionic co-polymer dispersant is utilized to obtain a low viscosity and high solid loading content of metal precursor particles through steric repulsion. Layer-less AM processes rely heavily on uniform recoating of the fabrication area to achieve monolithic 3D objects, however spontaneous rehydration and aggregation can occur leading to decreased surface quality and printing accuracy, see FIG. 6B. Incorporating a dispersant into the metal salt precursor slurry improves the rheological behavior and forms a protective hydrophobic layer around the particles preventing neighboring particles from attracting. Moreover, the hydrophobic layer around the particles prevents ambient water vapor from diffusing into the resin and rehydrating anhydrous inorganic metal salts resulting in longer printing times and increased stabilization compared to non-dispersant bearing resins, see FIG. 9A. In order to optimize the printing resin for the MMVP-VPP process, rheological measurements of different printing resin formulations containing varying amounts of dispersant and metal salt precursor concentrations are utilized to gauge the nominal dispersant and maximum solid loading concentrations, respectively. As shown in FIG. 8C, the rheological curves display that a suitable viscosity, less than 1 Pa*s, can be obtained for metal precursor resins with solid load concentration less than 65% (w/w) CuSO₄. The low viscosity printing resin can facilitate faster printing speeds since the resin will flow more easily to recoat the fabrication area. During post-processing, non-dispersant carrying resins produce printed structures with poor surface roughness and defects such as cracking compared to solutions with that contained a dispersant. Surface morphology and SEM images of Cu objects obtained from the MMVP-VPP process clearly show that without a dispersant the microstructure is non-uniform indicated by the presence of larger grains formed from particles that aggregated during printing to form a larger size, see FIGS. 6C and 8D. Furthermore, dispersant carrying precursor objects undergo uniform shrinkage that results in the excellent surface quality and uniform microstructure. Therefore, it may be beneficial that a dispersant is utilized so that high density metal precursor objects can be fabricated at higher speeds over the duration of multiple prints for long-term stability during the MMVP-VPP process.

The proposed MMVP-VPP can be applied to different material systems to produce components with either one or two metals to develop a wide range of available metals and alloys that can be fabricated by the continuous AM process. In a similar manner to the procedure outlined in previous sections for single metal, TGA-guided post-heat treatment is conducted on green body specimens to optimize the temperature profile for CuNi alloys containing 10%, 20%, and 30% Ni content. As shown in FIG. 12A, CuNi lattices with 10% Ni maintain their morphology during removal of organics (debinding), formation of metal oxide mixture of two metals (sintering/densification) and final alloy component. The composition of alloy components fabricated through the MMVP-VPP process are verified using electron dispersive X-ray spectroscopy (EDS) to observe the relative weight percentages of individual constituents within the final printed 3D object. Elemental mapping of Cu, Ni, C, and Si exhibit an even distribution of Cu and Ni atoms on the surface of CuNi gyroids with minimal contributions from C and Si from foreign contamination, see FIG. 12B. Furthermore, the volumetric shrinkage for CuNi lattices containing different solid loading concentrations can be accurately predicted through analyzing the change in diameter and height after different post-processing stages, see FIG. 12C.

Consequently, dimensional precision and high resolution can be achieved by the MMVP-VPP process by compensating for shrinkage a priori to obtain final alloy devices that can meet strict tolerance requirements. Adjusting the alloy composition for alloy precursor additives within the resin material system has a significant influence on the overall microstructure after post-heat treatment. As displayed in FIG. 12D, as Ni content is increased to 30%, for the same target sintering temperature of 1000° C.·the microstructure exhibits a higher degree of porosity compared to CuNi lattices with 10% Ni content. This may be due to the difference in sintering temperature of NiO compared to CuO leading to more well-defined grain boundaries for CuNi lattices containing less Ni. Moreover, experimental results indicate that the microstructure can be controlled by adjusting important printing parameters and material formulation such as solid loading concentration, alloy composition, and sintering temperature for specific physical performance and relative density. High resolution bioinspired CuNi lattices with feature sizes less than 50 microns can be achieved by the proposed MMVP-VPP process with applications such as coronary stents that are difficult to produce using traditional methods. Furthermore, since the shrinkage of two materials can be predicted by mathematical modeling, continuous multi-metal structures like copper to cupronickel alloy gradients can be realized with the low viscosity metal salt resin by performing a material exchange step during printing (see FIG. 12E). Therefore, the MMVP-VPP can be utilized to enable novel functional alloy gradient devices with tunable physical performance for emerging biomedical, aerospace, and electronic engineering challenges.

The metal mask video projection-based vat photopolymerization (MMVP-VPP) process is a novel, layer-less, and low-cost additive manufacturing (AM) technology, that integrates inorganic metal salt precursors, to fabricate metallic and metal alloy structures with excellent isotropic physical properties and surface quality. The MMVP-VPP process incorporates the working principle of continuous interface liquid production (CLIP), which utilizes light and an oxygen permeable window, to manufacture geometrically complex and smooth metal structures when compared with conventional layer-based metal AM methods. Because the structure is printed in a continuous fashion, high relative density and homogeneous physical properties can be obtained in the final metallic structure. Furthermore, the fabrication speed that can be attained by the MMVP-VPP process surpasses critical speed limitations of current state of the art metal AM technologies. Additionally, a vast library of metal and metal alloys can be utilized in the MMVP-VPP process providing increased design flexibility of metallic functional devices.

Energy deposition methods, such as selective laser sintering or electron beam melting, that fuse material to construct a physical metal object are expensive, have longer printing times, and printed structures display microscale surface defects from rapid thermal fusion processes. Mask imaging projection-based technologies have relaxed some these challenges, improved print times and surface quality, but display an obvious “staircasing effect” that promotes undesired heterogeneous behavior within the overall structure due to weak layer to layer adhesion. Conversely, MMVP-VPP is a cost-effective, sustainable, and robust metal 3D printing technology a broad range of applications in aerospace, biomedical, and industrial design where low surface roughness and isotropic behavior is required for optimal functionality, performance, and efficiency. Therefore, the MMVP-VPP process provides an ideal and affordable metal AM technology that can rapidly fabricate homogeneous metal, metal alloy, and multimetal 3D objects for the design of next-generation, novel 3D printed functional metal components. Additionally, this opens unique perspectives and intriguing opportunities for STEM students to learn new AM methodologies with the purpose of developing a broad skillset of 3D printing techniques that extends past commercial layer-based technologies.

Some novel aspects of the MMVP-VPP are as follows: (1) layer-less additive manufacturing process capable of fabricating metallic and metal alloy devices continuously with good surface quality (2) fabrication of homogeneous metallic parts with high relative density and homogeneous physical properties (3) speed advantage over layer-based technologies to fabricate metal and metal oxide printed structures and (4) low-cost and sustainable layer-less metal and metal oxide 3D printing process.

Currently, metal additive manufacturing (AM) technologies utilize layer-based methods to fabricate metallic structures which result in anisotropic physical properties, long print times. and poor surface quality. Furthermore, commercial metal 3D printers are costly to operate and service maintenance is expensive for defective components. The MMVP-VPP process circumvents these challenges since it is a low-cost and layer-less AM approach that can fabricate smooth and intricately designed metal parts without any “staircasing” effect. Moreover, the MVP-VPP process can print mesoscale and microscale parts orders of magnitude faster, with homogenous physical properties since it is printed continuously, than current technologies allowing for rapid design optimization. Besides, the MMVP-VPP process is a robust and sustainable printing process where water can be collected and repurposed from heat treatment of inorganic salts and successful or failed parts can be recycled using acid etching and filtration techniques. Therefore, this rapid prototyping technology will open new perspectives for the design of metal and metal alloy devices for biomedical, aerospace, and industrial applications via layer-less metal AM methodologies while simultaneously opening new pathways for STEM students to learn new 3D printing techniques in a controlled environment.

As observed from FIG. 6A, anhydrous metal salt particles are combined within a dispersant and monomer photocurable system to generate a low viscosity material that prevents aggregation, through repulsion of hydrophobic chains, between neighboring particles in high solid loading conditions. Because the printing resin maintains a homogenous dispersion of metal precursor particles, refilling during continuous fabrication is enhanced when compared to non-dispersant based resins that undergo rapid hydration from atmospheric water vapor which ultimately increases the overall viscosity during printing, see FIG. 6B. Selection of the optimal dispersant was firstly conducted by preparing fresh metal precursor resins, using six different types of dispersants (BYK-111, BYK-180, BYK-2013, BYK-2030, KH-560, & Triton X100) to observe sedimentation behavior after mixing. The relationship between rheological properties and photopolymerization of metal precursor inks, with large concentration of precursor additives, was determined to optimize the printing speed parameter to produce samples with excellent surface quality. Furthermore, the water resistance was greatly improved and led to increased printing stability over the course of multiple prints. Thermogravimetric (TGA) and Differential Scanning calorimetry (DSC) was performed to strategically generate debinding and sintering temperature profiles that can accommodate for rapid thermal events (i.e., outgassing of organic and combustion) that maintain their morphology through uniform shrinkage during metal oxide formation and metal oxide reduction to acquire metallic structures with high relative density and uniform grain size distribution, see FIG. 6C. Based on the presented work, homogeneous and dense metal precursor objects can be fabricated at faster printing speeds through the layer-less AM process by incorporating a dispersant to improve the rheological behavior and printing stability resulting in high fidelity printing of metallic structures and increased design iteration capabilities. Therefore, the method described has the potential to be extended to a wide variety of metal precursor inks to generate new emerging metals and alloys that are customizable and cost effective compared to traditional metal precursor AM technologies.

Copper sulfate pentahydrate (≥98.0%, Sigma Aldrich) is first dehydrated in a high temperature muffle furnace (1700X MTI Corp.) to produce anhydrous copper sulfate (CuSO₄) with the purpose of achieving a high solid loading content of CuSO₄ dispersed within the photocurable solution. The monomers 1,6-Hexanediol diacrylate (HDDA, Technical Grade 80%, Sigma Aldrich) and trimethylolpropane ethoxylate triacrylate (E-TMPTA, M_{N}=425, Sigma Aldrich) are combined and homogenized on a magnetic stirrer. Photoinitator (PI) Omnirad 819 (IGM) is utilized in this study to facilitate cross-linking via free radical photopolymerization with PI concentrations ranging between 0.5%-2% (w/w). In total, six different dispersants are used to aid in the dispersion of inorganic metal salt within the PI and monomer solution. The dispersants that are investigated are: BYK-111 (BYK, Germany), BYK-2030 (BYK, Germany), BYK-2013 (BYK, Germany), BYK-180 (BYK, Germany), KH560 (Sigma Aldrich), and Triton X100 (Sigma Aldrich). The dispersants are fully dissolved into the photocurable solution prior to ball milling to aid in the adsorption of metal salt additives onto the particle surface. The dispersant and photocurable solution are then placed into a planetary ball mill with zirconia milling balls while small batches of CuSO₄ are added and mixed to synthesize the metal precursor printing resin. The resin is milled at 350 RPM overnight to reduce the CuSO₄ particle size and acquire uniform dispersion of the metal precursors (solid phase) within the photocurable resin and dispersant (liquid phase). The concentration of CuSO₄ is adjusted to produce printing resins with solid loading contents of 50% (w/w), 55% (w/w), and 60% (w/w) of anhydrous CuSO₄.

Directly after ball milling, freshly prepared CuSO₄ printing resins are transferred into glass vials at equal initial heights to study the effect of different dispersants on the sedimentation and printing stability of metal precursors within the photocurable resin. Separation between the CuSO₄ and the photocurable resin is recorded at discrete time increments after milling. Sedimentation is probed by using a metal spatula to determine if there is a deposition layer at the bottom of the vial. After marking the top of sedimentation on the outside of the vials, the height of the deposition layer is then determined by measuring with a precision ruler.

The layer-less fabrication process for producing metal precursor objects involves the projection of a 2D light patterned mask image video with a digital micromirror device (DMD) consisting of an array of 1024×760 micromirrors onto the bottom surface of an optically clear resin tank composed of a thin layer of polydimethylsiloxane (PDMS). The image is further focused by a biconvex lens with a focal distance of f=150 mm. Mask image videos are generated from slicing the desired digital model into 2D grayscale images using a layer thickness of 5 microns per image. Individual mask images are then strung together using a video generation software (VirtualDub64) to make a mask image video that synchronizes with the velocity of the build platform. The metal precursor printing resin is deposited within the PDMS coated resin tank which is selectively cured onto the build platform which continuously ascends during the fabrication process. Photocurable resin continuously refills the previously solidified regions, after the build platform moves upwards by a predefined height and time interval, to produce metal precursor objects in a layer-less manner. Curing characteristics of metal salt printing resin is conducted by projecting a 2D light beam in the shape of an 8 mm by 8 mm square using different exposure times and light intensities. The heights of the thin films are measured using precision calipers to determine the curing depth. The build platform velocity is adjusted based on the cross-linking investigation and rheological properties to produce metal precursor structures with smooth surfaces. Metal precursor objects are washed in HDDA to clean residual uncured resin from the surface of the printed part and dried using an airbrush. The parts are then transferred into a post-curing chamber and exposed to a UV lamp for 15 minutes to fully cross-link the remaining monomers before post-processing.

Rheological measurements are carried out on metal precursor resins using a Discovery HR-30 rheometer with a dynamic shear rate sweep from 10-100 s⁻¹. Photoinitator is purposefully omitted during viscosity experiments to prevent solidification of the printing resin from ambient light to obtain accurate results. Resin material is placed in between two parallel circular plates with diameter of 25 mm each. A height gap of 525 μm is utilized for all rheological measurements.

Thermogravimetric analysis (TGA) is performed on green body samples fabricated through the layer-less printing process, with a CuSO₄ concentration of 60% (w/w), using a LABSYS Evo instrument. A segment of the green body is extracted, weighed, and placed in a small alumina crucible before testing. The temperature profile during analysis consists of a ramping rate of 5° C. min⁻¹ to 1000° C. to determine temperature regions associated with significant mass loss from burning of organics and metal oxide formation. At the same time, differential scanning calorimetry (DSC) is performed to quantify heat absorption and release by the sample during the ramp to 1000° C.

After drying and post-curing, green body samples are placed in a tube furnace with inert flowing gas (N₂) in order to remove dispersant, cross-linked monomers, and excess photoinitator at maximum temperature of 600° C. Debinded samples further have their temperature increased in an ambient O₂ environment (˜18%) to achieve metal oxide structures with a target sintering temperature of 1000° C. The optimized debinding and sintering temperature profiles are determined through thermogravimetric analysis as discussed in Section 2.3.2. Subsequently, thermal reduction is conducted in a reducing atmosphere (5% H₂ and 95% Ar) within the tube furnace, where the sintered metal oxide structures transform to pure metallic objects at 800° C. for 10 hours.

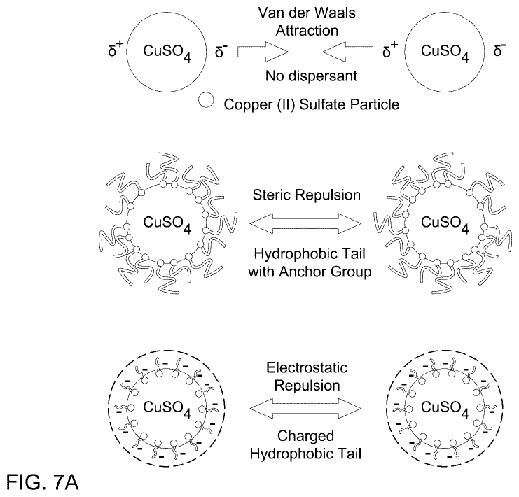

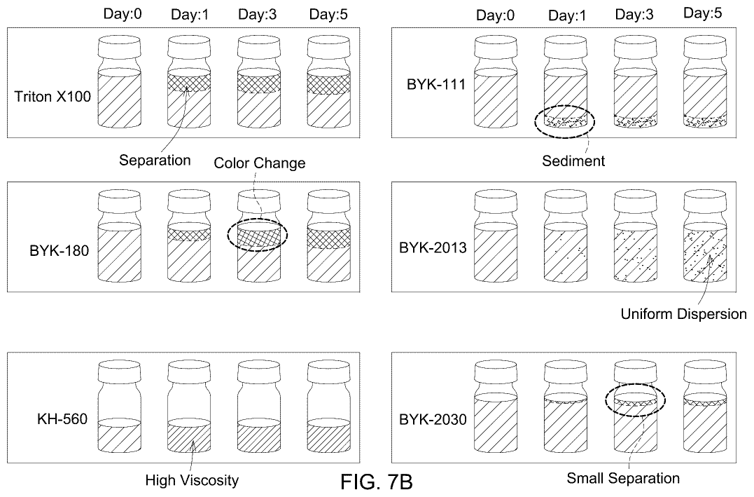

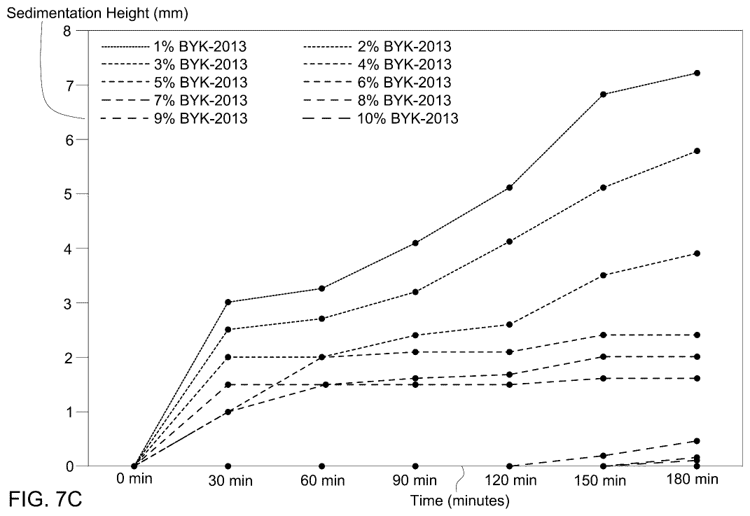

To further improve the solid loading content and water resistance of anhydrous CuSO₄ salt within the photosensitive solution, dispersant is required to reduce the overall attraction between adjacent particles within the mixture. The overall attractive and repulsive forces that occur within the solution arise from difference in surface charges of the CuSO₄ particles that can spontaneously form aggregates from Van der Waals forces, shown in FIG. 7A. Moreover, rehydration of dispersed anhydrous CuSO₄, through diffusion of atmospheric water vapor in high relative humidity conditions, can dramatically increase the overall viscosity of the material since CuSO₄·xH₂O will both increase the particle size and separate readily from the solution. Physical separation is the direct result of the incompatibilities from dissolving water in organic monomers (hydrophobic), leading to inhomogeneous dispersion of CuSO₄ in the nonaqueous solution and poor printing stability. Consequently, dispersant selection is an imperative step towards obtaining low viscosity metal precursor inks that can seamlessly refill the fabrication area during continuous printing. Two mechanisms for achieving stabilization of CuSO₄ within the photosensitive monomer solution are investigated in this work which include steric repulsion and electrosteric repulsion, as depicted in FIG. 7A. Dispersants consisting of molecules with hydrophilic and hydrophobic regions prefer to orient the hydrophobic chain within the photocurable solution and anchoring of the hydrophilic head to the particle can be promoted by using either non-ionic or ionic groups. Therefore, six individual dispersants are utilized to prepare metal salt printing resins and compared to assess their stability during metal precursor fabrication.

Sedimentation experiments are conducted on CuSO₄ printing resins to determine the stability of the mixtures with different dispersants under the effect of gravity. Using consistent solid loading of CuSO₄ and dispersant concentrations of 60% (w/w) and 5% (w/w), respectively, the separation between the solid and liquid phase, sedimentation, and turbidity are recorded for 24 h (1 Day), 72 h (3 Days), and 120 h (5 Days), as shown in FIG. 7B. Out of the six dispersants used, TX-100 and BYK-180 show the largest separation distance between the solid and liquid phase after 24 h indicating that these dispersants are ineffective at maintaining the homogeneous distribution of CuSO₄ particles seen initially after milling. Moreover, the dispersant KH-560, a silane coupling agent, generates a viscous, paste-like resin that displays little separation within the column over the five-day period. However, the highly viscous resin would require a recoating process, using a doctor's blade or similar tool, to deposit new material during printing and thus cannot be fabricated in a continuous manner. BYK-111, BYK-2013, and BYK-2030 exhibit the highest turbidity over 120 h with minor separation between the liquid and solid phases occurring at 72 h after mixing for each dispersant. Amongst the three dispersants, BYK-111 shows the highest removal of CuSO₄ from the mixture at 120 h and the sedimentation within the column of liquid is almost 49% compared to BYK-2013 and BYK-2030 with total sedimentation percentages of 18% and 38%, respectively. Furthermore, a rapid assessment of the rheological properties of 50% (w/w) CuSO₄ resins with BYK-2013 and BYK-2030 dispersants shows that apparent viscosity less than 1 Pa·s is achieved for all samples at shear rates between 10-100 s⁻¹. As a result, the dispersants BYK-2030 and BYK-2013 are chosen for the next trial of experiments to investigate the overall sedimentation rate during layer-less fabrication.

Continuous printing of metal precursor objects relies heavily on the uniform deposition and rapid delivery of new, uncured material to the fabrication area during printing. The continuous recoating process ensures that a homogeneous framework of dispersed CuSO₄ particles is achieved within the solidified part after printing. Consequently, layer-less fabrication requires that the dispersed CuSO₄ and photocurable resin mixture preserves the initial uniform distribution of CuSO₄ particles and minimizes the effects of particle sedimentation during printing. This is the most critical factor when considering a dispersant since sedimentation during printing will inhibit photopolymerization in the material resulting in poor cross-linking density from incident light exposure. To address these challenges and generate a homogeneous network of CuSO₄ particles, the sedimentation rate of CuSO₄ resins containing BYK-2013 and BYK-2030 dispersants with varying concentrations between 7-10% (w/w) are investigated. When the solid loading content of the resin is held constant at 50% (w/w), after 24 h BYK-2013 dispersant shows much lower sedimentation values, in general less than 5 mm, compared to BYK-2030 which exceed 15 mm. Moreover, for 10% (w/w) BYK-2013 and BYK-2030 resins after 120 h, the sedimentation is 88% lower for the BYK-2013 resin compared to BYK-2030 which demonstrates excellent stability at high solid loading. A significant decrease in sedimentation height is observed when the BYK-20132 dispersant concentration is increased from 7% (w/w) to 8% (w/w) which reveals that for concentrations above 7% (w/w) sedimentation is nearly eliminated. Therefore, BYK-2013 is selected as the most ideal dispersant since it can maintain a homogenous distribution of CuSO₄ with no observable sedimentation after 24 hours.

Since the layer-less fabrication process can generate metal precursor structures with microscale features at high speeds, the CuSO₄ resin may maintain the homogenous dispersion, under the effect of gravity, over the course of multiple prints. Typically, the fabrication speeds using CLIP allow for the fabrication of millimeter scaled components within an average print time of approximately 10 to 20 minutes. Although the printing time is significantly shorter than layer-based AM methods, any sedimentation during printing resin can result in undesired defects in the printed part. In order to better understand the sedimentation mechanism of different mixtures during the continuous printing, the sedimentation rate for resins with different dispersant concentrations are determined over the course of 180 minutes. The sedimentation rate for BYK-2013 resins with concentrations≤7% (w/w) exhibits high rates of 0.5-1.5 mm h⁻¹ right after milling and the general trend evinces that total sedimentation height after 180 min is reduced as dispersant concentration increases, see FIG. 7C. Dispersant concentrations of 8-10% (w/w) BYK-2013 show superior stability with overall sedimentation height reaching a minimum of 0.1 mm for 10% (w/w) concentration of dispersant after 180 min. The results show that the onset of sedimentation occurs at 120 min. for 8% (w/w) concentration and 150 min. for 9-10% (w/w) concentration. However, for resin mixtures containing 1% (w/w) to 7% (w/w) dispersant concentration, the onset of sedimentation occurs after 30 minutes with lower concentrations exhibiting larger heights of 3 mm compared to higher concentrations around 1 mm. Therefore, dispersant concentrations ranging from 8-10% (w/w) give excellent stability for continuous fabrication process for each print.

Curing characteristics of printing resins containing BYK-2013 dispersant are investigated in order to produce metal precursors with good surface quality and dimensionally control. Solidification of the polymerizable resin occurs when a 2D patterned light beam is projected to the bottom surface of the resin tank by a DLP projector. Light penetrates the resin to selectively cross-link the desired region as new material continuously is deposited to grow the structure homogenously. For photosensitive solutions with a suspended solid phase, the light penetration and curing depth is significantly influenced by the distribution of metal salt particles within the solution. As illustrated in FIG. 8A, metal salt solutions with inadequate dispersion of the solid phase will ultimately form larger aggregates leading to varying spatial distance and sizes of dispersed particles resulting in a larger penetration depth of light. Conversely, homogeneously dispersed metal salt systems with uniform particle size reduce the number of pathways in which the incident light can travel leading to an overall reduction in penetration and curing depth. Therefore, it is imperative to gage the curing depth of metal salt and dispersant resins since the cross-linking rate of the resin may be synchronized with the ascension of the build platform to generate smooth surface features during the layer-less AM process.

As shown in FIG. 8B, the working curves of 50% (w/w) metal salt resin with 10% (w/w) BYK-2013 at different light intensities displays that curing depth decreases with light intensity. The light intensity of the system is adjusted by tuning the grayscale value of projected image and measured using a photometer. For example, using full light intensity at 140 mW cm⁻², a curing depth of 137 μm is obtained compared to 93 μm for the lowest intensity of 51.3 mW cm⁻² for a constant exposure time of 30 seconds. Furthermore, increasing the exposure time from 30 seconds to 40 seconds, for the full intensity light beam, increases the curing depth from 137 μm to 190 μm. Using the working curves, the frame rate of the mask image video is related to the velocity of the build platform to provide sufficient energy to solidify the material before continuing to the next section of the 3D object. Therefore, information of the curing characteristics of dispersed metal salt resin system can be utilized to optimize the printing parameters to achieve high resolution parts at faster printing speeds.

Assessing rheological properties and flow behavior of CuSO₄ resins is a critical step in developing the material formulation since the BYK-2013 dispersant will influence the apparent viscosity and overall refilling capabilities of the resin for continuous printing. Low viscosity printing resins are required for the layer-less AM process because the recoating mechanism is limited by the rheological behavior of the resin. The viscosity of the resin can additionally give insight into the stability between the liquid and solid phase of the printing resin. As shown in FIG. 8C, for a constant solid loading of 50% (w/w) CuSO₄ the apparent viscosity is lowest for resin with 3% (w/w) BYK-2013 and begins to increase to higher values exceeding 0.1 Pa·s as the concentration of dispersant is increased. For example, at a constant shear rate of 80 s⁻¹ the viscosity of resins with concentrations of 1% (w/w), 3% (w/w), and 7% (w/w) are 0.05 Pa·s, 0.03 Pa·s, and 0.16 Pa·s, respectively. This indicates at 3% (w/w) concentration of dispersant the particles are more evenly dispersed and can flow more uniformly compared to 1% and 7% dispersant concentration. Consequently, different concentrations of dispersants can lead to higher viscosities since concentrations lower than the optimal dispersant concentration, in this case 3% (w/w), can potentially aggregate from partial particle coating. In contrast, higher concentrations of dispersant can lead to entanglement of free dispersant chains since the particle has a threshold of dispersants that can attach to its surface. Furthermore, the shear thinning behavior of resins containing BYK-2013 dispersant is reduced significantly compared to resins without dispersant. This result indicates that metal salt particles are uniformly dispersed with BYK-2013 since they exhibit good flow behavior with nearly constant viscosity at all tested shear rates. Therefore, increased force applied to the metal salt resin doesn't result in the disaggregation of large particles to decrease the viscosity and the particles uniformly flow with no visible thinning at higher shear rates.

In general, high density metal structures are obtained from increased solid content in the printed precursor part and consequently require that a high concentration metal salt precursor is introduced into the photocurable solution. Comparing the rheological curves for photocurable solutions with a range of metal salt concentrations reveals the influence of the solid phase and dispersant on maximum achievable solid loading compatible with the layer-less AM process. Depicted in FIG. 8C, metal salt concentrations larger than 60% (w/w) show a significant increase in viscosity above 1 Pa·s. Examining viscosity measurements at a constant shear rate of 80 s⁻¹. metal salt resins containing 50%-60% (w/w) concentration exhibit viscosities around 0.06 to 0.14 Pas while the viscosity for 65% (w/w) jumps to 2.87 Pa·s and further increases to 4.42 Pa·s for 70% (w/w). Moreover, the viscosities for 65% (w/w) and 70% (w/w) at different shear rates varies and therefore exhibits non-Newtonian behavior potentially indicating that larger aggregates are being broken up at higher applied forces. Overall, the viscosities observed for the range of 50-60% (w/w) solid loading content is favorable during the printing process and can achieve adequate recoating to rapidly form metal precursor parts with smooth surface features.

The influence of printing speed and solid loading concentration of anhydrous CuSO₄ is investigated with the purpose of optimizing the surface quality and printing speed during fabrication. As previously mentioned, the viscosity of the resin is affected by the concentration of metal salt and amount of dispersant used and consequently the optimal dispersant for 50% (w/w), 55% (w/w), and 60% (w/w) may be obtained empirically from both sedimentation and rheological measurements to accurately determine the effect of printing speed on each material system. As demonstrated in FIG. 8D, the surface quality of metal salt precursor gyroids printed using the continuous photopolymerization process is greatly improved and faster printing speeds are obtained from lower metal salt concentrations rather than higher concentrations. For example, to obtain the same surface quality metal precursor gyroid as 50% (w/w) CuSO₄ printed at a speed of 20 μm s⁻¹, the 60% (w/w) CuSO₄ solution requires a slower speed of 10 μm s⁻¹ suggesting that the light penetration is weaker for high solid loading of CuSO₄ particles. Moreover, for a resin system containing 55% (w/w) CuSO₄ the printing speed is in between the 50% (w/w) and 60% (w/w) resins with a maximum printing velocity of 15 μm s⁻¹. In general, it is observed that as metal salt concentration is increased, the maximum allowable printing velocity decreases. Therefore, smooth surface features and intricate morphologies can be fabricated with the layer-less AM process with a wide range of metal salt loading resulting in adjustable physical properties from either porous or dense metallic structures after thermal synthesis.

To demonstrate the printing stability of dispersant-based resins, CuSO₄ resins with and without BYK-2013 are compared by fabricating cubic gyroids using the continuous AM process in a controlled printing environment. Fresh CuSO₄ resin is deposited into the glass tank and allowed to completely coat the thin layer of PDMS on the bottom. The average print time is approximately 20 minutes for the largest sample and is used as the metric for comparison of the two resin material systems. As shown in FIG. 9A, after 15 min. resin without dispersant exhibits thickening through aggregation and hydration with some of the resin adhering to the build platform after being risen out of the tank. However, BYK-2013 dispersant shows minimal hydration even after 120 min. and exhibits no sedimentation on the bottom of the printing tank. Furthermore, the surface morphology of cubic gyroids with dispersant exhibit superior surface quality while non-dispersant based resins display surface defects from aggregation of CuSO₄ particles. Resin containing the dispersant BYK-2013 shows excellent stability and water resistance compared to non-dispersant systems. Therefore, resin can withstand multiple prints, even in relatively humid environments, without rehydration while maintaining a homogenous and high solid loading of CuSO₄ particles during fabrication to improve the surface quality of metal precursor objects.

Since the anhydrous CuSO₄ particles readily absorb water vapor from the atmosphere in high relative humidity environments, the dispersant may completely coat the CuSO₄ particle to prevent rehydration. BYK-2013 is composed of a copolymer consisting of styrene-maleic anhydride with quaternized ammonium groups that serve as the hydrophobic, hydrophilic, and ionic group, respectively. When the dispersant is homogenized in the photocurable solution and anhydrous CuSO₄ is introduced into the mixture, the maleic anhydride portion of the copolymer (polar region) is attracted to the hydrophilic region of the CuSO₄ crystalline structure, see FIG. 9B. Moreover, the ionic group of quaternized ammonium groups can further facilitate this interaction since the charge of the copolymer can promote anchoring on the particle surface. Once absorbed onto the particle surface, the styrene region of the copolymer (aromatic and non-polar) is naturally hydrophobic and self-assembly results in these regions pointing outward and extending into the monomer solution which is also non-polar. Consequently, self-assembly occurs spontaneously based on the hydrophobic and hydrophilic properties of the particle and solution mixture and in this manner provides a mechanism for preventing rehydration and stable dispersion of CuSO₄ particles. For example, when ambient water vapor attempts to chemically bond with the CuSO₄ particle, the aromatic ring of styrene repels the incoming water molecules acting as a barrier such that penetration is avoided. Furthermore, the hydrophilic sites are already occupied by the high molecular weight dispersant and therefore requires a more favorable driving force to cause rehydration of the CuSO₄ such as increased H₂O concentration into the mixture. In general, the self-assembly of the high molecular weight dispersant can provide a stable printing resin by shielding the particles with non-polar regions of the copolymer while keeping the dispersant absorbed onto the particles surface through quaternized ammonium anchors and hydrophilic maleic anhydride groups to block rehydration.

Optimization of post-processing parameters associated with monomer, dispersant, and photoinitiator removal and metal oxide formation are important to preserving the overall morphology of the printed part after heat treatment. To ascertain the temperatures at which these events occur, thermogravimetric analysis (TGA) and differential scanning calorimetry (DSC) are conducted on small cubic metal precursor green body samples, with 50% (w/w) CuSO₄, printed through the layer-less fabrication process. As depicted in FIG. 9C, TGA results show that mass loss begins around ˜150° C. with a dramatic decrease in mass loss of approximately 49% up to temperatures of 425° C. Upwards of 425° C., the monomer, unused PI, and dispersant are removed from the green body sample leaving behind the suspended CuSO₄ as indicated by the region of constant mass between temperatures of 425° C. to 700° C. This is verified to be monomer and dispersant removal since the DSC results show a large peak when heat is released around temperatures of 355° C. and 405° C. of 80 mW and 120 mW indicating the burning of organic material, respectively. Further heating of the metal precursors results in an additional mass loss of 30% with the total mass reduction being 72% of the original sample. The mass of 30% at 714° C. to 800° C. is associated with removal of trisulfide gas from CuSO₄ and oxidation to form the metal oxide particles. Moreover, DSC results exhibit an endothermic reaction, heat being absorbed by the system, which correlates to the endothermic reaction of metal oxide formation. Subsequently, the mass loss at this stage is fixed and increasing the overall temperature is associated with the sintering process of metal oxide to form dense metal oxide structures.

Derivative of the curve (DTG) in FIG. 9C shows peaks at temperature values that have an the most rapid rate of mass loss percentage at inflection points of the overall graph to 1000° C. There are two major peaks at temperatures of 355° C. and 410° C. with 3 minor peaks at 195° C., 735° C., and 800° C. As a direct result, the dwell temperatures for post-processing are chosen at these temperature values. In order to minimize the rapid outgassing of cross-linked monomer and dispersant, debinding is first performed in an inert N₂ environment to reduce the heat release during pyrolysis, as seen in FIG. 9C. Next, the samples undergo metal oxide formation by increasing the temperature, in ambient air, to 715° C. and 800° C. as exhibited by the TGA and DSC for 2 hours. To increase the overall mechanical properties of the metal oxide sample, sintering is performed at 1000° C. to obtain dense metal oxide structures that can be converted to metal in a reducing environment. Subsequently, metal parts are obtained by reducing the metal oxide to form the metallic part in a reducing environment of H₂ gas at a temperature below the sintering temperature, in this case 800° C. for 10 hours (see FIG. 9C). In general, TGA/DSC assisted post-processing can give key insights into the optimal parameters for post-processing different metal salts, such as zinc chloride or iron sulfate, to produce metal objects from precursor materials.

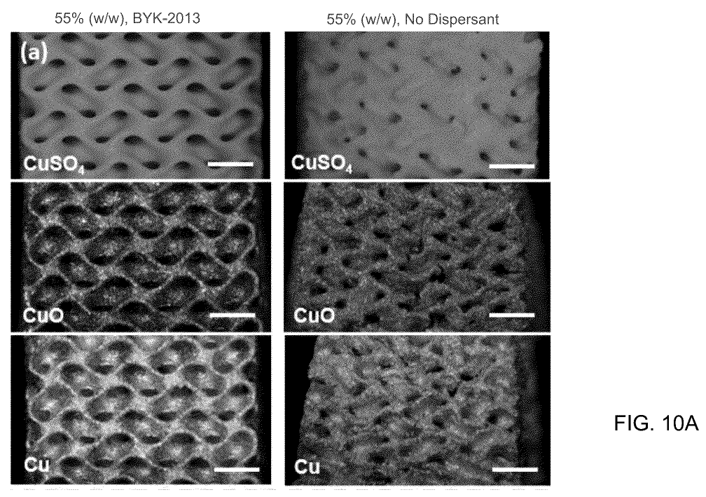

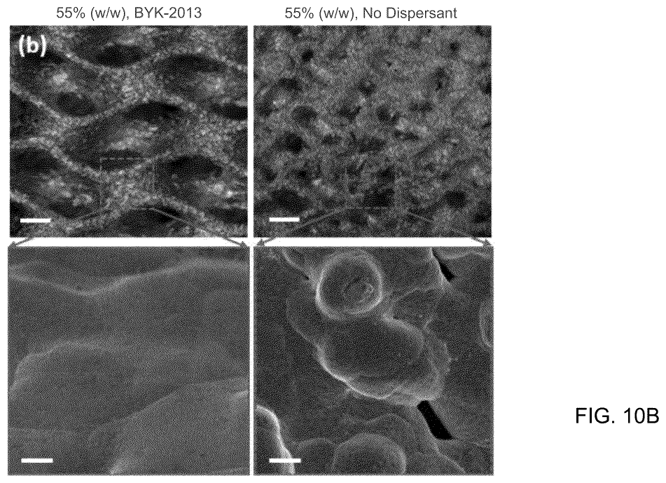

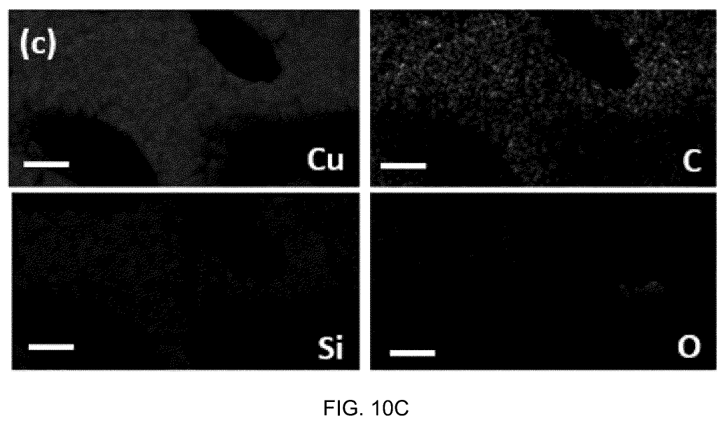

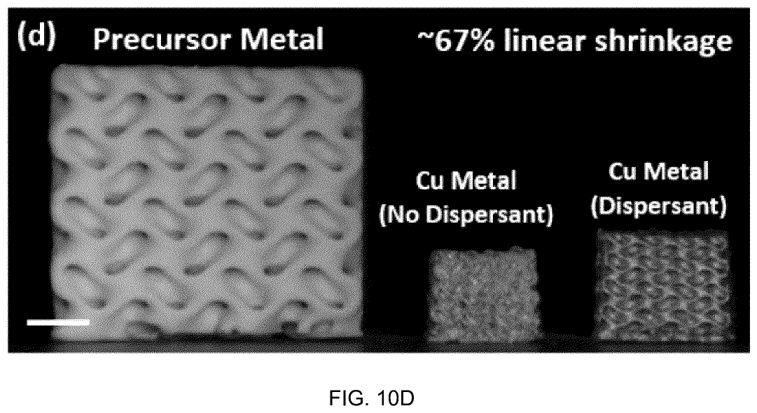

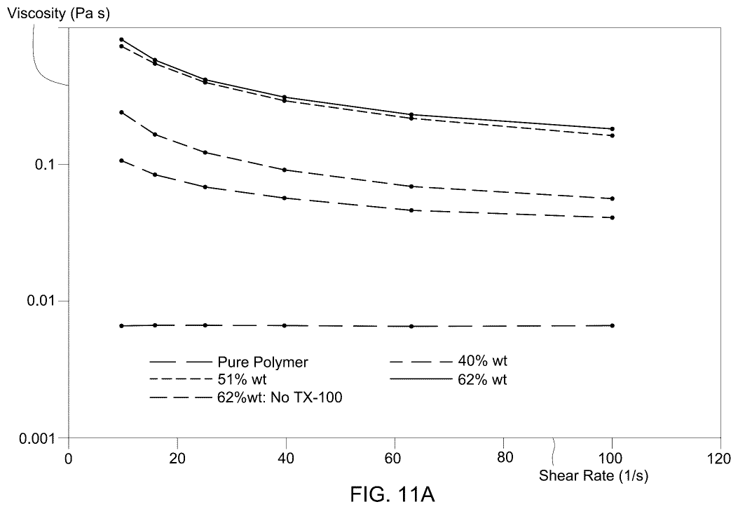

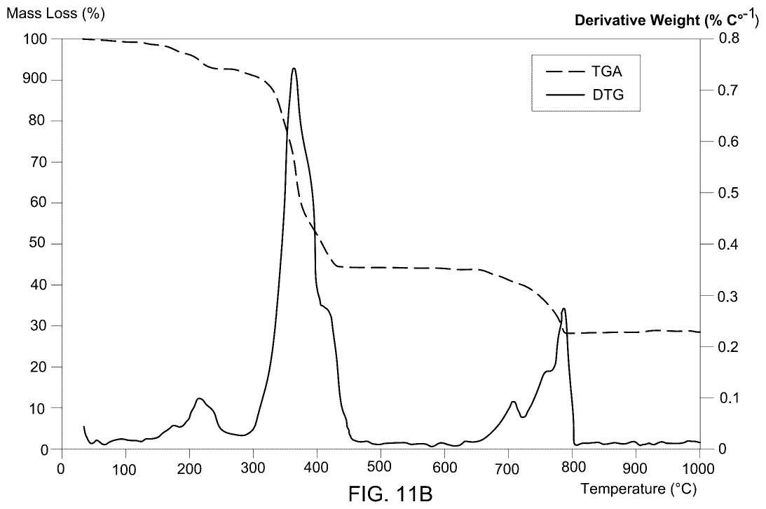

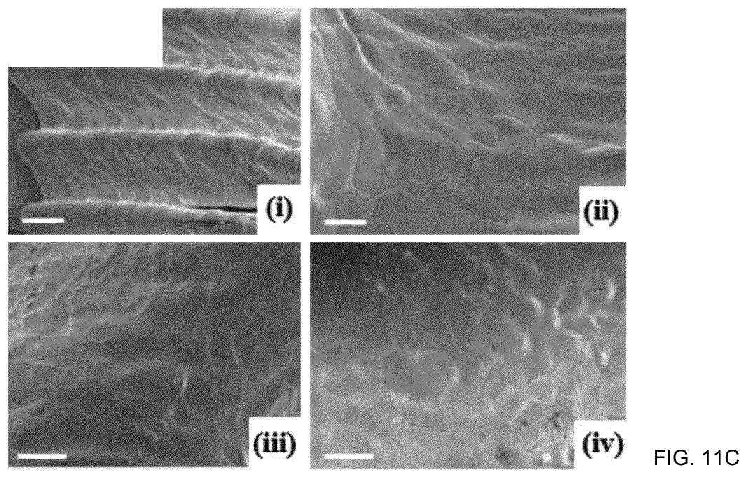

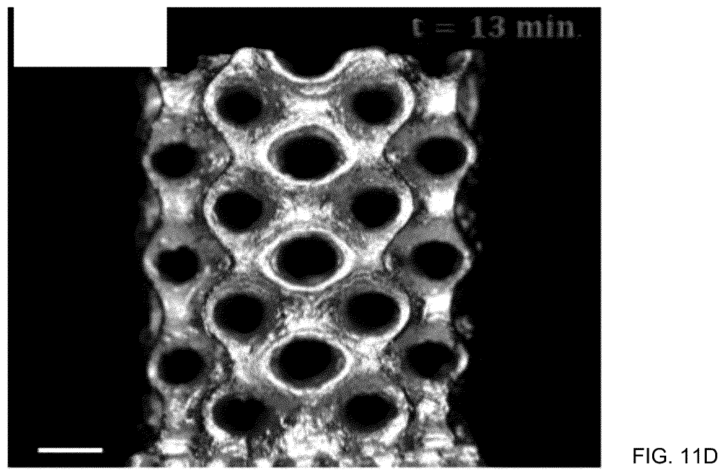

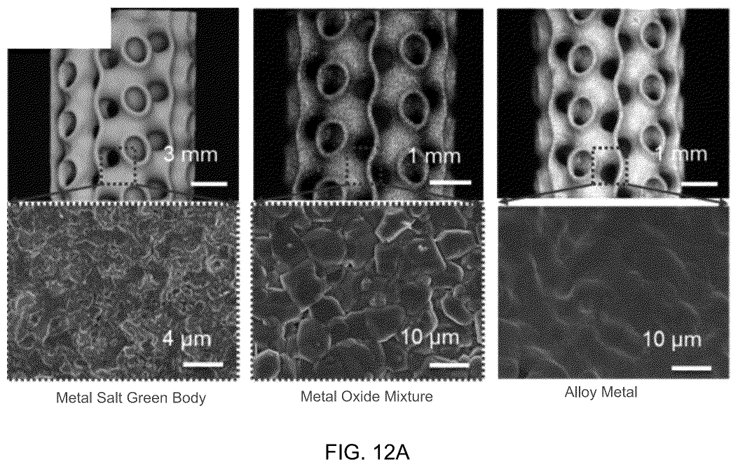

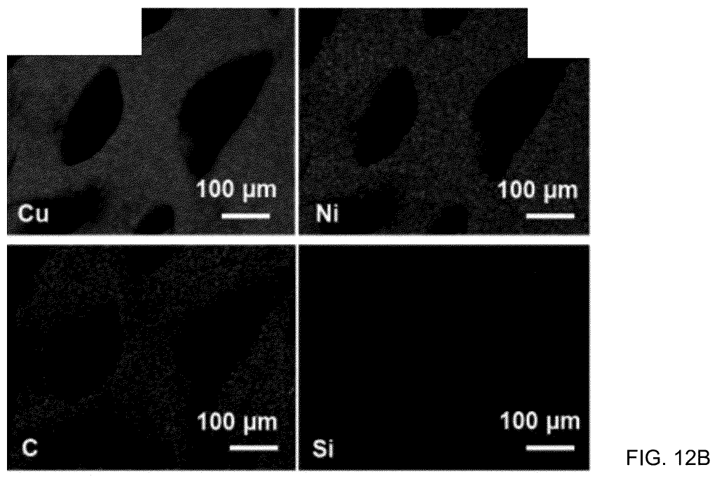

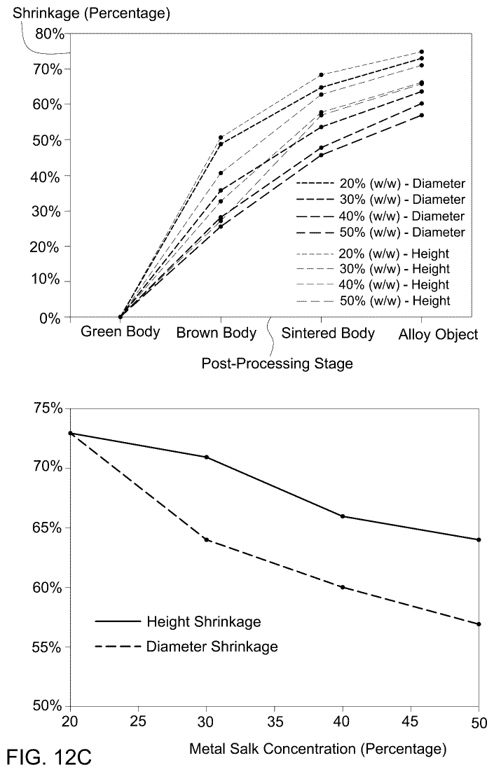

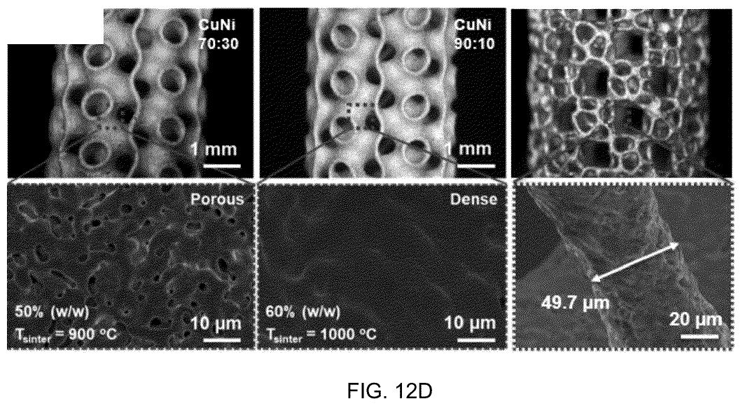

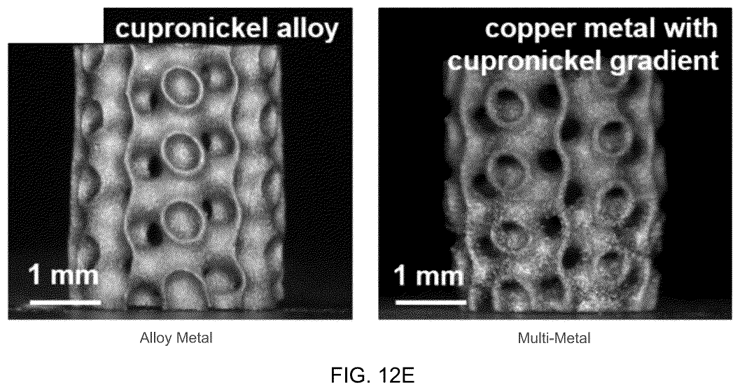

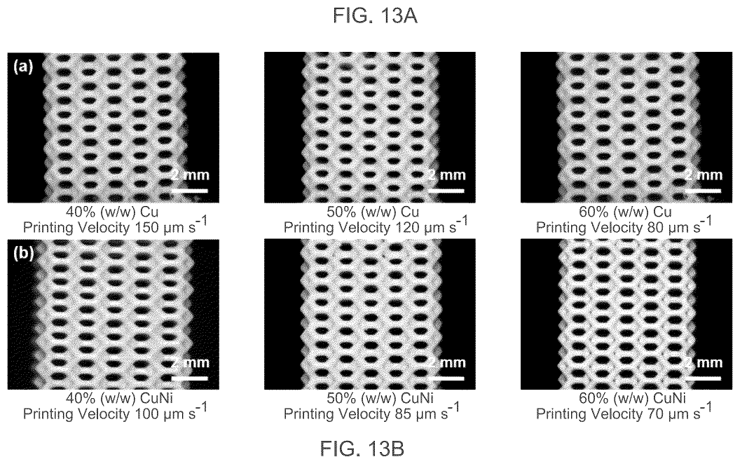

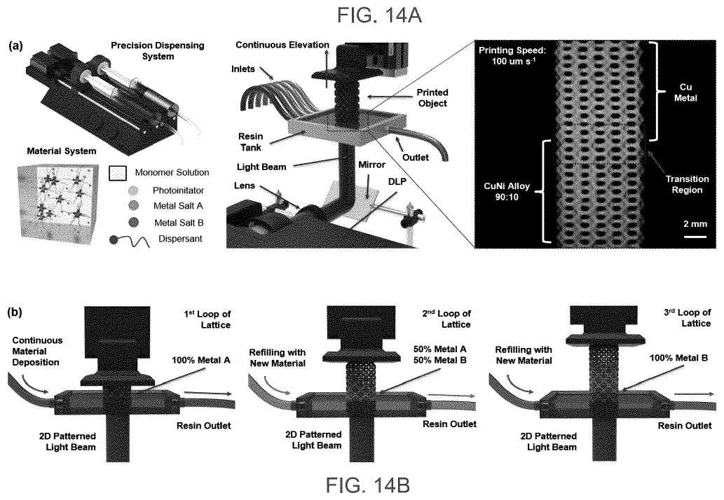

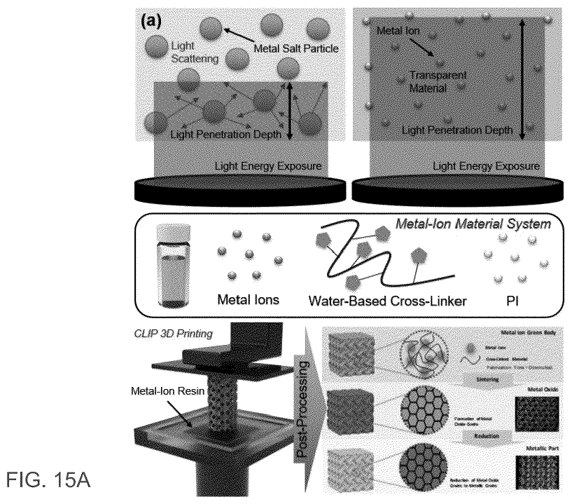

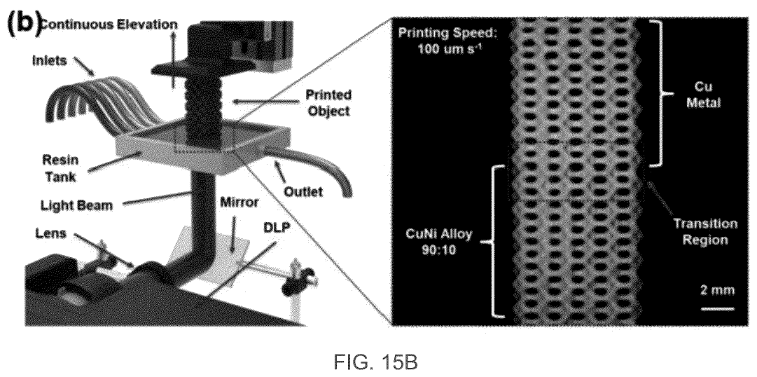

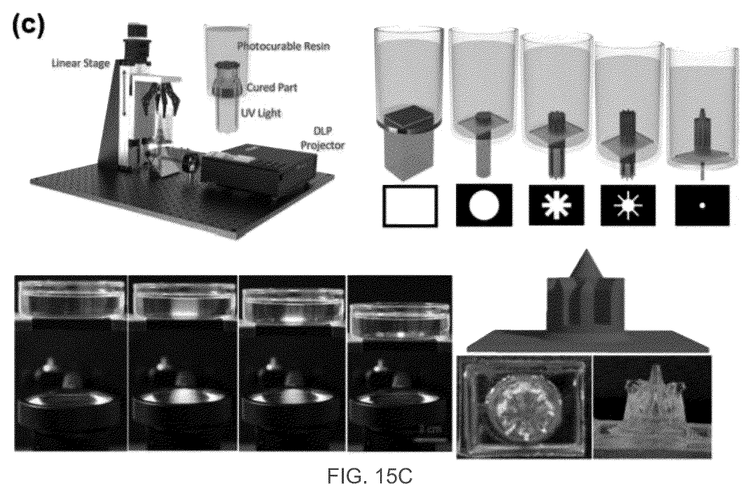

To generate metallic structures with high relative density, dispersant and monomer removal, as well as metal oxide formation, may be conducted in a meticulous manner to prevent defects in the metal object from rapid outgassing and residual stresses during heating. Synthesizing metal structures from metal precursor material involves post-heat treatment of CuSO₄ to first form metal oxide (CuO) through debinding and sintering processes, utilizing the temperature profiles discussed in Section 3.3.3, followed by subsequent reduction of CuO to Cu in the final synthesis step. As depicted in FIG. 10A, Cu cubic gyroids printed with 55% (w/w) CuSO₄ resin and BYK-2013 dispersant display excellent surface morphology after post-processing with no visible defects compared with non-dispersant based Cu gyroids. For non-dispersant carrying resins, rehydration and aggregation leads to poor surface quality and inhomogeneous distribution of CuSO₄ particles in the printed part as shown from the filling of macroscopic pores with excess material in the cubic gyroid. Consequently, foreign particles on the surface of the gyroid could potentially lead to non-uniform heating during organic removal and metal oxide formation leading to cracks before the reduction post-processing step. After metal oxide formation, the dispersant-based Cu cubic gyroid maintains its overall morphology with no observable surface cracks while the non-dispersant based gyroid displays large cracks and non-uniform shrinkage. Because the particles are distributed homogenously in the dispersant-based gyroid, metal oxide can easily be synthesized since the shrinkage and sintering processes are isotropic and proceed without large thermal gradients or voids from poor dispersion. Furthermore, the non-dispersant metal oxide gyroid exhibits anisotropic behavior during post-heat treatment which is evinced by the flaring effect in the metal oxide structure since the edges of the gyroid curve inward starting from the base. Overall, the structural integrity and morphology for both parts are maintained after metal oxide formation indicating that the debinding and sintering steps are the most important in mitigating crack formation and anisotropic behavior in the metal printed part.

To verify the chemical composition of cubic gyroids after post-heat treatment, energy dispersive spectroscopy (EDS) and X-ray diffraction (XRD) are employed to visualize the distribution of elements and extract relative weight percentages of different constituents to gage the effectiveness of the proposed post-processing parameters. As shown in FIG. 10B, the elemental mapping of the surface indicates that the gyroid is composed of primarily Cu metal with small amounts of C, Si, and O. Furthermore, the distribution of Cu is uniform throughout the structure without hot spots on the map to indicate the presence of more concentrated Cu regions. The presence of Si and O within the sample is introduced during the post-heat treatment since the experiments are performed in a quartz tube furnace in alumina crucibles. Furthermore, the remaining C displayed on the elemental mapping is from residual dispersant and monomer chains that have been decomposed and remain within the sample. XRD results show that the relative weight percentage of Cu is approximately 99.2% while Si and O are only 0.5% and 0.1%, respectively, demonstrating that the post-process treatment of metal precursors is successful in producing high Cu content metallic parts.

To assess the effect of dispersant on the microstructure of 3D printed copper objects using the layer-less AM process, SEM images are taken of each Cu gyroid with BYK-2013 and without dispersant. As shown in FIG. 10C, the copper gyroid printed using the BYK-2013 has a homogenous distribution of metal precursor material consequently leading to a dense microstructure with uniform grain size. Copper gyroids printed without dispersant display a microstructure with larger grains, formed from aggregates during printing, surrounding grains with smaller sizes. During the sintering and reduction process the uniform particle size is important to obtaining a homogenous distribution of grains. When the particle size varies throughout the metal oxide part, the sintering leads to heterogeneous microstructure with some grain sizes much larger than the general distribution of grains since they are likely formed from aggregation of particles in the resin during printing. Therefore, during thermal synthesis, if the heating distribution throughout the part is non-uniform it may lead to larger cracks and deformation resulting in microstructures with anisotropic behavior which is undesirable for the final metal structure. Moreover, micropores shown in SEM images without the dispersant are a byproduct of poor particle distribution since the uneven heating outgases more rapidly in some sections resulting in major cracks and uneven shrinkage. Consequently, to producing metal gyroids with superior surface morphology and dense, uniform microstructure, can be realized since the initial distribution of CuSO₄ particles and heating is uniform during the entirety of the post-heat treatment process.

To obtain 3D printed metal structures with dimensional accuracy after post-processing, the linear shrinkage of metal precursor objects printed with and without dispersant are compared. As depicted in FIG. 10D, uniform shrinkage of approximately 67% of the original size occurs for metal structures that previously contained dispersant. Conversely, metal objects formed without dispersant show similar shrinkage however exhibit non-uniform shrinkage in the X and Y direction around 69% while the Z direction is approximately 75% shrinkage. Furthermore, the shrinkage closer to the base of the non-dispersant gyroid is smaller than the top surface causing a warping effect from anisotropic shrinkage. This result supports the previous claim that metal precursors without dispersants produce objects with heterogeneously dispersed particles with random sizes while the dispersant bearing solutions form more uniform grain sizes and physical properties. Since the linear shrinkage for metal parts printed with the MVP-VPP process can be predicted a prior using this simple technique, dimensional precision can be acquired for meso- and microscales structures with high resolution resulting in feature sizes down to 50-100 microns. Furthermore, since the morphology is preserved, intricate and highly complex metal structures can be obtained to generate next-generation biomedical and aerospace functional device printed through metal AM at much faster speeds and better surface quality than most traditional AM methods such as SLM, EBM, or DIW.

The sedimentation rate, viscosity, and printing performance of a photocurable metal precursor resin is determined with the purpose of obtaining a high solid loading and stable dispersion of inorganic metal salt that is compatible with the continuous AM process. Dispersant selection is important to improve the refilling process, water resistance, and structural integrity of metal precursor green bodies. Turbidity and sedimentation of CuSO₄ resins containing different dispersants demonstrate that BYK-2013 and BYK-2030 greatly decrease the separation between the solid and liquid phases after 120 hours compared to the other dispersants. Dispersant selection is further narrowed by conducting rheological and sedimentation rate measurements of each resin system. Resins containing upwards of 8% (w/w) BYK-2013 dispersant have a lower apparent viscosity of 0.34 Pa·s and prevent the formation of a solid deposition layer after 24 hours in comparison to resins containing BYK-2030. The relationship between curing depth and light intensity is modeled and utilized to optimize the surface quality and printing speed of metal precursor 3D structures. Concentrations of CuSO₄ within the range of 50-60% (w/w) are favorable for layer-less printing with higher concentrations resulting in slower printing speeds due to the influence of light scattering from high particle loading conditions. The water resistance of CuSO₄ resin is significantly improved from the self-assembly of hydrophobic and hydrophilic regions of the BYK-2013 copolymer dispersant which prevents rapid hydration from the presence of atmospheric water vapor. Stable thermal decomposition of green bodies is promoted through TGA-guided heat treatment and demonstrates that copper printed parts maintain their morphology during post-heat treatment leading to intricately designed metal parts with high relative density and uniform microstructure. Therefore, the proposed method of obtaining low viscosity and high solid loading metal salt resins through use of a copolymer dispersant provides a unique method for preparation customizable metal precursor resins to fabricate metal and alloy 3D objects for rapid design iteration that are cost-effective.

A layer-less MVP-VPP method for rapidly fabricating 3D metal objects using photosensitive metal precursor resins may achieve printing speeds exceeding 100 μm s^{31 1} for both single and alloy metal precursors. A multi-metal CLIP printing process can enable the creation of 3D objects with controllable metal gradients by selectively depositing different metal precursor resins during fabrication. Additionally, a water-based, transparent metal precursor ink may overcome limitations of particle-based systems, offering improved light penetration and reduced viscosity for enhanced printing performance and multi-metal object creation.

One of the primary advantages of the layer-less MVP-VPP method is that it can quickly cross-link the photosensitive metal precursor resin to fabricate 3D objects within minutes in contrast to traditional mask image-based DLP printing consisting of multiple individual layers with discrete exposure times to solidify the material. To provide the fastest possible printing speed, the light intensity of DLP projector can be increased to improve the curing performance of the material resulting in faster printing velocities and build times. As displayed in FIGS. 13A-13B, both single and alloy metal precursor lattices can achieve velocities exceeding 100 μm s⁻¹ for solid loading concentrations of 40% (w/w) Cu and 40% (w/w) CuNi (10% Ni content) with maximum printing velocities of 150 μm s⁻¹ and 120 μm s⁻¹, respectively, for a constant light intensity of 203 mW cm-2. Consequently, the higher light intensity from the DMD device promotes free radical photopolymerization kinetics and, to compensate for this increased rate of cross-linking rate, the velocity of the printing platform and frame rate of the mask videos are adjusted to obtain dimensionally accurate printed parts. It should be noted that CuNi alloy lattices require slower printing speeds compared to pure Cu metal lattices which align closely to previous experimental results, using a light intensity of 144 mW cm-2. Addition of Ni into the suspension alters the refractive index and curing properties of the metal precursor printing resin leading to longer required exposure times for solidification. Furthermore, as the solid loading concentration of the metal precursor solution is increased, the printing speed generally decreases due to the rising contribution of light scattering effects and reduction of light penetration depth resulting in reduced curing depth. Because of the addition of more densely packed CuSO₄ and NiSO₄ particles, the incident light exposure is reflected, and the average distance travel is significantly reduced leading to slower curing characteristics compared to material systems with lower particle concentrations. Therefore, the printing velocity of the build platform can be optimized based on the cross-linking rate to accurately produce 3D metal precursor objects with intricate geometries and excellent surface quality.

Achieving high quality multi-metal components through conventional metal additive manufacturing (AM), such as direct energy deposition (DED) and powder bed fusion (PBF), that utilize innovative material exchange processes during fabrication has become a promising tool for generating intricate multi-metal devices that exhibit a wide range of different physical properties not offered by a single metal. However, current metal AM technologies are limited by long printing times and expensive hardware from the intrinsic process of printing individual layers and material exchange processes to selectively deposit and build the desired 3D multi-metal object. In contrast, multi-metal 3D printing can be facilitated using the proposed metal precursor approach which can circumvent these challenges providing multi-metal components with controllable gradients with high precision and rapid printing speeds. As illustrated in FIG. 14A, the multi-metal CLIP printing process is primarily driven by continuous refilling of the fabrication area, by precision resin dispensing systems, that flows fresh uncured multiple metal precursor material into the resin vat which is subsequently cured into the net shape of the 3D object. For example, 40% (w/w) Cu/CuNi multi-metal 3D objects can be achieved utilizing a printing speed of 100 μm s⁻¹ by simply interchanging the low viscosity metal precursor resins during layer-less 3D printing. Shown in FIG. 14B, lattices with composable metal gradients are programmed a priori by selecting predefined regions of arbitrary height for a specific metal/alloy precursor resin which is selectively deposited during layer-less printing to form the desired gradient multi-metal structure. Consequently, by accurately modulating the deposition of metal/alloy precursor material into the resin tank through various inlets during the CLIP printing, gradient multi-metal 3D objects with a smooth transition region can be achieved. For example, multi-metal Cu/CuNi kelvin lattices, containing Cu and CuNi in the lower and upper region, respectively, are fabricated by first dispensing Cu metal precursor resins at a rate of 150 μL s⁻¹ for a predetermined amount of time, based on the printing velocity and desired height of Cu within the lattice, to generate the lower portion of the metal lattice. Once the 3D object has risen by the desired Δh after some time interval, the resin dispensing system begins to gradually add CuNi resin that eventually completely replaces the previous material to form the upper CuNi region of the Kelvin lattices. In this way, the proposed 3D multi-metal 3D printing approach provides a unique and flexible process for creating multi-metal 3D objects with selectively physical properties such as corrosion resistance or thermal conductivity for the design of innovative and novel thermal management devices.

As outlined in previous sections, metal precursor resins that utilize inorganic anhydrous metal salt particles and dispersants to provide a versatile and low-cost method for obtaining low viscosity metal precursor inks can be directed incorporated into the layer-less AM method to build metal, alloy, and multi-metal 3D objects. However, the major drawback and limitation of the proposed material system is that integrating anhydrous metal salt into a hydrophobic medium inherently produces increased light shielding effects from the high solid loading of precursor materials and insolubility of inorganic metal salt in a monomer-based photosensitive material system resulting in low light penetration depth and limited printing speed range. To circumvent these challenges, a water-based and transparent metal/alloy precursor printing ink with low viscosity is proposed that consists of dispersing metal ions within a solution composed of a water-based cross-linking agent and photoinitator (see FIG. 15A). Since the metal precursor printing ink is transparent, when compared to particle-based suspensions, the light penetration depth is significantly increased since incident light can pass through uninhibited. In particle-based system, the light is reflected by the precursor particles suspended within the photosensitive medium and progressively increases as the solid loading of particles is increased. Moreover, water-based and particle-less metal precursor inks do not require a dispersant because metal ions are dissolved in the water-based photosensitive material and consequently will not absorb ambient water vapor from the atmosphere when compared to anhydrous metal salt. The influence of continuous refilling of the fabrication area by the water-based precursor ink during CLIP printing is dramatically impacted since the overall apparent viscosity of the material is reduced and can more readily deliver fresh uncured materials as the platform ascends. Post-processing to form dense metallic objects follows the same principle as the particle-based system, TGA-assisted post-processing optimization, to generate temperature profiles during dehydration of green bodies, removal of organic material, formation of metal oxide, and reduction from metal oxide to metal in a H₂ environment. Additionally, the water-based precursor inks can be more easily incorporated into the proposed multi-metal printing process to aid in mixing between the two constituents (see FIG. 15B). Furthermore, transparent metal precursor solutions can be utilized to generate multi-metal and metal 3D objects through advanced layer-less additive manufacturing techniques, such as volumetric 3D printing (FIG. 15C), to further enhance the printing speed, homogeneity, and overall physical performance of microscale metallic objects because the light can readily penetrate deeply into the material system during printing. Therefore, this water-based particle-less metal precursor printing ink can be utilized to enable the rapid prototyping of many different functionally graded metals or single metals/alloys which open new and exciting perspectives on the design and implementation of cost-effective and lightweight designs with applications spanning from biomedical to aerospace technologies.

A number of implementations have been described. Nevertheless, it will be understood that various modifications may be made without departing from the spirit and scope of the disclosure. Accordingly, other implementations are within the scope of the following claims.

1. A method of fabricating a three-dimensional metallic object, comprising:
mixing a photocurable resin with anhydrous metal salt powder or dissolving metal salt powder to form a metal salt resin, wherein the metal salt resin is a metal salt slurry or a metal salt liquid resin;
dispensing metal salt resin into a light projection area;
receiving a digital model of the metallic object;
receiving a mask image video of the digital model, the mask image video comprised of a collection of two-dimensional mask images that each represent a cross-sectional area of the metallic object;
projecting the mask image video and a light beam into a tank containing the metal salt resin; and
printing the metallic object with the metal salt resin from the tank as a build platform positioned above the tank moves upward, wherein each cross-sectional area of the metallic object is selectively cured with the light.

2. The method of claim 1, wherein the build platform moves upward from the tank at a constant velocity.

3. The method of claim 2, wherein the constant velocity is between 10 μm s⁻¹ and 300 μm s-1.

4. The method of claim 1, wherein printing the metallic object includes a printing speed of at least 10⁷ μm³ s⁻¹ for a feature size of 100 μm.

5. The method of claim 1, wherein the metal salt resin comprises 20%-65% (w/w) metal salt such as CuSO₄ and a dispersant.

6. The method of claim 5, wherein the dispersant is an ionic copolymer dispersant.

7. The method of claim 1, wherein different types of metal salt resins are dispensed into the resin tank at a controllable deposition rate.

8. The method of claim 1, wherein printing the multi-metallic object includes the formation of alloys and gradient metal structures.

9. A system for fabricating a three-dimensional metallic object, comprising:
a tank configured to contain a metal salt resin comprising a photocurable resin mixed with or dissolving anhydrous metal salt powder;
a build platform positioned above the tank;
a projection device configured to project a mask image video and a light beam into the tank; and
a controller configured to:
receive a digital model of the metallic object,
generate a mask image video of the digital model comprised of a collection of two-dimensional mask images that each represent a cross-sectional area of the metallic object, control the projection device to project the mask image video and light beam into the tank, and
control movement of the build platform to print the metallic object as the build platform moves upward or control the movement of the tank to achieve linear volumetric printing.

10. The system of claim 9, wherein the controller is configured to control the build platform to move upward at a constant velocity between 10 μm s-1 and 300 μm s-1.

11. The system of claim 10, wherein the controller is configured to control printing of the metallic object at a printing speed of at least 10⁷ μm³ s⁻¹ for a feature size of 100 μm.

12. The system of claim 9, wherein the metal salt resin comprises 20%-65% (w/w) metal salt such as CuSO₄ and a dispersant.

13. The system of claim 12, wherein the dispersant is an ionic copolymer dispersant.

14. The system of claim 13, wherein the ionic copolymer dispersant comprises a styrene-maleic anhydride copolymer with quaternized ammonium groups.

15. A metal salt resin for fabricating a three-dimensional metallic object, comprising:
a photocurable resin;
anhydrous metal salt powder dispersed within or dissolved into the photocurable resin; and
a dispersant,
wherein the metal salt resin has a viscosity between 0.01 and 1 Pa·s at a shear rate between 10 and 100 s\hat{ }-1.

16. The metal salt resin of claim 15, wherein the anhydrous metal salt powder comprises copper sulfate (CuSO₄) or a chemical compound formed by the reaction of a metal with an acid.

17. The metal salt resin of claim 16, wherein the anhydrous metal salt powder is present in an amount of 20-65% (w/w) of the metal salt resin.

18. The metal salt resin of claim 17, wherein the dispersant is an ionic copolymer dispersant.

19. The metal salt resin of claim 18, wherein the ionic copolymer dispersant comprises a styrene-maleic anhydride copolymer with quaternized ammonium groups.

20. The metal salt resin of claim 19, wherein the photocurable resin comprises a mixture of 1,6-hexanediol diacrylate (HDDA) and trimethylolpropane ethoxylate triacrylate (E-TMPTA) or water-soluble photocurable polymer and hydrogel.
